(19) United States
(12) Patent Application Publication
(10) Pub. No.: US 2026/0024084 A1
(43) Pub. Date: Jan. 22, 2026

(54) Systems and Methods for Computationally Evolving Digital Assets and Controlling Digital Asset Transactions

(71) Applicant: Frontage Road Holdings, LLC, Wilmington, DE (US)

(72) Inventors: Josh Williams, Sacramento, CA (US); Erik Lewis, Lafayette, CA (US); Neelesh Tiruviluamala, Palo Alto, CA (US); Altaf Michael Termezy, San Francisco, CA (US); Bela Nikhilray Pandya, San Ramon, CA (US); Linda Chew, Seattle, WA (US)

(21) Appl. No.: 19/276,914

(22) Filed: Jul. 22, 2025

Related U.S. Application Data
(60) Provisional application No. 63/674,165, filed on Jul. 22, 2024.

(51) Int. Cl. G06Q 20/40; G06Q 20/38

(52) U.S. Cl. CPC G06Q 20/401; G06Q 20/389

(57) ABSTRACT

Embodiments include systems and methods for transacting and evolving digital assets received in a distributed ledger based “loot-box” or “gacha” system. In an embodiment, a blockchain computer system for computationally evolving digital assets and controlling digital asset transactions includes a blockchain computer network and an embedded virtual machine (VM). The blockchain computer network is configured to process transactions of digital assets. The embedded virtual machine (VM) is configured to decode, via a decoder, a smart contract on the blockchain computer network. The smart contract is configured to, based on at least one user activity value, computationally evolve at least one digital asset. The smart contract is further configured to control, based on at least one threshold criterion, at least one transaction of a computationally evolved digital asset of the at least one digital asset on the blockchain computer network.

### RELATED APPLICATION(S)

This application claims the benefit of U.S. Provisional Application No. 63/674, 165, filed on Jul. 22, 2024, and Appendix entitled “Blockchain Game Economy Design,” Forte, 21 pages. The entire teachings of the above application and Appendix are incorporated herein by reference.

### BACKGROUND

A blockchain may be implemented as a peer-to-peer (P2P), electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

Blockchain may be used for implementation of “smart contracts” that can be associated with digital assets. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets.

An area of blockchain-related interest is the use of “tokens” to represent and transfer assets via the blockchain. A token serves as an identifier that allows an asset to be referenced from the blockchain. A token may be fungible or non-fungible, and divisible or indivisible. Fungible tokens are interchangeable. In other words, fungible tokens of the same type are identical in specification, and each fungible token is identical to another fungible token of the same type. Fungible tokens may be divisible into smaller amounts. Similar to currency, where bills can be divided into coins of an equivalent value, fungible tokens may be divisible. Fungible tokens may also be indivisible, similar to commodity-like atomic units with properties of interchangeability and indivisibility. Non-fungible tokens (NFTs), however, cannot be replaced with other tokens of the same type. NFTs represent non-fungible assets. Non-fungible assets have unique information or attributes. Each NET is unique and differs from other tokens of the same class. Some NFTs may be an aggregate of tokens, and thus divisible into constituent component tokens. Other NFTs may be truly unique tokens that cannot be subdivided. Blockchain gaming systems may use tokens that are fungible or non-fungible, divisible or indivisible to create different parts of a game, such as rules, characters, weapons, and skins.

Cryptocurrency wallets may be implemented to securely store and manage blockchain assets, tokens, NFTs, and cryptocurrencies. These wallets may allow users to spend, receive, and trade digital assets.

### SUMMARY

Blockchain gaming token economies can become unstable in response to an oversupply of tradeable key electronic assets. A blockchain gaming token ecosystem, such as a free-to-play (F2P) or play-to-earn (P2E) gaming system, typically manages “sources” and “sinks” of assets based on player engagement. As the supply of the key assets increases, there may be a risk of an oversaturation of assets if token supply outpaces demand. A surplus of key assets can create imbalance in the blockchain gaming token ecosystem. This imbalance can be an issue in the sustainability of a blockchain gaming platform as it may cause economic instability, and inadvertently incentivize players to behave in ways that are disruptive to the in-game economic mode or engage in grey market activity. The present disclosure includes embodiments that enable a blockchain gaming token ecosystem that can be configured to manage and control supply and transfer of key assets to ensure sustainability of the system.

Heroes are an example key asset in video games. They are designed to improve or ascend through, for example, leveling up the Hero during gameplay. While game players desire the ability to trade heroes, game developers and producers typically disable the ability to trade heroes. Allowing players to trade heroes typically does not provide a sustainable economic benefit to the game developers/producers. Further, enabling trading heroes can potentially fall within a legal framework that regulates money laundering, and therefore may necessitate technical controls and registrations to ensure compliance with know your customer (KYC) and anti-money laundering (AML) legislation. Further, enabling trading and selling of heroes can create a black market for the electronic asset outside of the game and create opportunities for money laundering, further frustrating the game economic ecosystem and security of the platform for developers/producers, as well as exposing players to fraud or counterparty risk. Malicious actors, for example, may seek to breach security protocols and conduct backdoor transactions of heroes at little to no cost, for personal gain. To address this, game developers/producers may allow trading of a hero, however, the trade transaction automatically triggers the hero to reset to its default properties in response to the trade, which is undesirable for gameplayers because this diminishes the value of heroes ascendence during gameplay, or even shutdown the account associated with the player. In non-blockchain based games, the trading of heroes may be via an in-game currency, which lacks real value convertibility. While enabling ownership and control of key electronic assets like heroes is a desirable feature for players, it can create security and compliance issues and can be disruptive to the game economic ecosystem.

A loot box is another example of a key asset in video games. A loot box (also referred to as a loot crate or prize crate) is a consumable virtual item which can be redeemed to receive a randomized selection of further virtual items, or loot. Loot boxes are a derivative of randomized loot drop systems from early video games and can provide a player with a range of virtual goods ranging from customization options for a player's avatar or character to equipment, such as weapons and armor. A loot box can provide a lucrative form of monetization in video games for developers/publishers.

A loot box, once interfaced with by a player, typically triggers an algorithm that randomly generates virtual item(s). Generally, the chances of a loot box containing certain items varies by the rarity or in-game value of the items and may be disclosed by a rate drop. Loot boxes are typically designed to contain an unknown assortment of virtual items that can be redeemed or utilized in-game. Loot boxes may contain digital items of varying scarcity, such as collectibles, in-game skins for characters and weapons, new abilities, or upgrades for a game character or items. As loot boxes have the potential to contain key virtual goods, such as heroes, loot boxes are highly coveted by players and can be susceptible to fraud and chargebacks, which are a costly expense to games and publishers. Some loot boxes contain digital items of significant value, which may be re-sold in online secondary markets. Loot boxes may also be known as gacha, based on gashapon (capsule toys), and integrated into gacha games.

Loot boxes are one form of chance-based gamification used in video games. The contents of the loot box are generally not disclosed before it is opened. In gamification, loot boxes may be a component of a compulsion loop of game design to engage players. Because of the use of random chance to secure virtual goods after committing real-world funds, loot boxes integrated in video games may be considered a form of gambling and subject to gambling regulations. Gambling laws are not uniform and differ by country and state. Criteria that often constitutes an illegal “wager”: (1) risking something of value (2) on the occurrence of a chance event (3) for a potentially valuable prize, and thus, some traditional loot boxes may constitute an illegal wager.

Although loot boxes and heroes provide value to the gaming experience, these key assets can present technical implementation challenges in gamification that can impede integration in blockchain gaming platforms. In light of the technical complexities involved ensuring security and compliance, while further ensuring the system is configured to thwart money laundering, fraud, and secondary market and black-market transactions, the benefit to including these key assets, such as heroes and loot boxes, in blockchain gaming can outweigh the risks resulting from technical and compliance implementation challenges.

The present disclosure provides blockchain gaming solutions and advances in configuring key assets (heroes and loot boxes) with fail-safes to address the challenges noted above, while enabling transparency, fraud mitigation, compliance, and security for heroes and loot boxes and enabling trading within wider game ecosystems including enabling cross-chain transactions.

In a disclosed embodiment, a blockchain gaming system is provided where a player receives a fail-safe game item, such as a hero or an item, in a “loot box” fail-safe system or a “gacha” mechanic fail-safe system. The fail-safe game item is configured to ensure it is in compliance and includes controls for fraud mitigation and security. A fail-safe “loot box” or “gacha” machine may present the player with a random item of a plurality of items of variable rarity and value contained in a loot box. The determination of whether the fail-safe item is in compliance with a relevant jurisdiction's laws is a computational, fact based, and design specific inquiry. The “loot box” fail-safe system or a “gacha” mechanic fail-safe system on a blockchain network may further be configured to provide potential traceability of transactions and the facilitation of secondary markets on the blockchain network. The potentially volatile prices for a fail-safe item that is configured as a non-fungible token (NFT) includes fail-safe design and disclosure to ensure compliance and security.

In a disclosed embodiment of a blockchain gaming system, to mitigate security risks and ensure compliance, a token that has real monetary value, or the potential for real monetary value, is entirely decoupled from chance-based outcomes in games, such as “loot boxes” or “gacha” mechanic style rewards, in addition to a disclosure which provides transparency to protect players. Game developers may offer a “gacha” style mechanic to introduce heroes to players via the sale of, for example, a player pack, allowing players to open the pack and receive heroes with varying attributes. However, the introduction of actual in-game player contribution to the hero is what makes the hero valuable and tradeable on a secondary market. For example, in an embodiment a hero may gain experience, special gear, or a rare skin that makes the Hero more valuable. These player contributions are not based on chance or luck, but rather engagement (e.g., time spent playing or participation in a special event) or skill based.

In an example, embodiment a blockchain system may be configured to enable trading of key electronic assets, such as hero fail-safe tokens implemented, while preserving scarcity to ensure blockchain economic ecosystem is sustainable and secure. The blockchain system may include a blockchain computer network configured to process transactions of digital assets. A virtual machine (VM) may be configured to decode, via a decoder, a smart contract on the blockchain computer network. The smart contract, may for example, be configured as an encoded implementation of a salient electronic asset, such as a hero. The smart contract may be configured to respond to user action by computationally evolving the salient digital asset. The blockchain system may be configured to control, based on at least one threshold criterion, at least one transaction of the at least one digital asset on the blockchain computer network.

In an embodiment of the disclosure, a blockchain computer system may include an electronic game platform and a blockchain computer network configured to process transactions of digital assets. The blockchain computer system may include a virtual machine (VM) configured to decode via a decoder a smart contract. The smart contract may represent a salient digital asset, such as a hero. The blockchain computer system may be configured to provide a hero generation mechanism that is responsive to a completed transaction by a first player of the game platform. The blockchain computer system may be configured to associate a hero fail-safe token with the first user. Based on an achievement level of the first user in the electronic game platform, the hero fail-safe token may be further configured and transformed during gameplay based on performance and capabilities of the first game player. The hero fail-safe token may be further transformed and processed by the system based on an achievement level of a second player in the electronic game platform, thereby further computationally evolving and transforming the hero fail-safe token. In this way, based on performance and skill during gameplay, a cluster of players (guilds) can collectively cause the hero fail-safe token to transform and evolve.

In an embodiment, the game platform may enable a player to secure the hero fail-safe token using a chance-based mechanic. For example, the chance-based mechanic may include a pack containing an epic or legendary hero fail-safe token. A hero fail-safe token, for example, may be configured as a fungible tokens (divisible or indivisible) or as a non-fungible token (NFT). In an example preferred implementation, the hero fail-safe tokens are limited and initialized with identical default stats. The hero fail-safe token may be configured to evolve, and as it evolves it may vary based on rarity. The hero fail-safe token may be configured to evolve based on player engagement/skill with maximum stats and/or skill tree paths or depth based on rarity of the hero fail-safe token. In an embodiment, the evolution tree consists of distinct pathways, each based on the distinct type of player contribution. In an example, player engagement during gameplay may be quantified using metrics, such as experience points (XP). Experience points may be configured as a computational measure of a player's performance in the virtual environment quantifying a player's mastery in the computer game, such as completing tasks, collecting items. The experience points may be configured in cumulative nature to build over time and enable the player (or cluster of players) to level up.

In one embodiment, a hero fail-safe token may be upgraded to level up/evolve. It may be upgraded by minting a new hero combined with all of its related assets (e.g. weapons, cosmetics, gear). For example, a hero fail-safe token may initially be a common hero minted as a fungible token, but upgraded by reminting as an NFT or an indivisible token to reflect its uniqueness and its evolution. In another embodiment, the hero fail-safe token may be upgraded by encapsulated the hero and all of its assets into a container, or by binding the hero and its related assets via inheritance computationally.

Gamification may be controlled based on experience points of the hero to limit access to certain areas of the virtual game world, which can break up a player's journey and control the difficulty of available tasks during gameplay. Thus, as the hero fail-safe token evolves, it encapsulates player(s) contributions. For example, a hero fail-safe token may be configured to iteratively evolve via milestone achievements and earn traits (evolution traits). A recursive and iterative computational process can be called via the smart contract of the hero fail-safe token to enable an evolution loop that unlocks evolution paths for the hero fail-safe token and enables the earning of evolution traits.

Embodiments include a computer-based system for enforcing conditional transfer of hero fail-safe tokens. In an embodiment, hero fail-safe tokens may be configured to restrict trading. As an example, a hero fail-safe token may be configured to unlock trading on the blockchain or the secondary market if the hero fail-safe token meets the minimum evolution threshold. In this way, for example, only “evolved” hero fail-safe tokens are gated based on evolution threshold to enable trading on the secondary market. In an embodiment, attributes that players earn (e.g. via skill) during gameplay may be tokenized and tradeable on the secondary market. The transferring of Hero tokens may also be gated by both the buyer and seller, completing know your customer protections.

Hero fail-safe tokens may be secured by players via a loot box in the gaming environment. A loot box may be configured to provide in-game rewards including a random assortment of virtual goods. Embodiments of the present disclosure can provide a transparent and trustworthy loot box implementation. In an example embodiment, the loot box may be configured as a smart contract, thus enabling a video game to invoke computational functions that are executed in parallel by nodes on a blockchain network.

In an embodiment, each evolution of the hero fail-safe token is fully transparent and recorded on the blockchain. Player(s) engagement and skill during gameplay, evolution traits may be quantified via the smart contract using metrics and timestamped/recorded on chain. In this way, players know when the evolution transaction occurs as the game calls the smart contract of the hero fail-safe token and updates the blockchain with the transaction record. In this way, each hero fail-safe token evolution can be transparent and recorded on the blockchain-enabled platform. Further, restrictions for transferring ownership of hero fail-safe tokens can be configured in the smart contracts of the hero fail-safe tokens. The application programming interface that enables a transfer of hero fail-safe tokens from one blockchain platform to another can initially preempt transfer of ownership, as well as cross-chain transfers, and unlock those features as the hero fail-safe token evolves and meets a threshold. Such an embodiment may provide transparency to a player regarding, for example, the number of possible NFTs in circulation, distribution of NFTs based on rarity, and predetermined mint sequence in which tokens may be received from, for example, a loot box. As rare NFTs are claimed by users, this is recorded on a distributed ledger technology, and will affect the probability of users receiving different categories of NFTs.

The hero fail-safe token transferred cross-chain can be encapsulated with royalty enforcement rules and enable shared revenue streams for recurring royalties for subsequent sales of the hero fail-safe token. Such embedded royalty enforcement rules that govern transfers of the hero fail-safe token may preserve its value and provide a means of enforcing agreements and encoded rules governing transfers of the hero fail-safe token, regardless of whether or not said transfers occur entirely within the blockchain system in which the hero fail-safe token was minted.

In an embodiment, a blockchain computer system may be provided that incentivizes producers to mint tokens in the network. The system may provide a producer node with a producer token, which enables the producer to mint tokens in the blockchain network. For example, the producer token may be configured to automatically enable and unlock access to a token minting factory system in the blockchain network. With access to the token minting factory system, he producer node can mint cryptographic tokens in the blockchain network. The number of instances of tokens minted by the producer node may be quantified and tracked and the results may be recorded on the blockchain or in the metadata of the producer token. If the producer node mints a threshold number of tokens, the system can respond by staking cryptographic token rewards for the producer node. The producer may stake a shard of the token reward.

The system may record the quantified and tracked instances of tokens minted by the producer node. The number of instances and tracking data and further analytics regarding the producer's tokens minted, such as the types of tokens (hero, loot box, skins, etc.) and sale value, may be recorded in the metadata of the producer token or on the blockchain. The system iteratively checks whether the producer node has met a threshold production volume of minted tokens. The blockchain network may restrict the number of instances of a cryptographic token minted by the producer node to control the supply of cryptographic tokens in the blockchain network. The transaction value associated with an instance of a token minted by a producer node may be restricted by the blockchain network.

If producer node is a member of a production guild, and the guild meets its production threshold, then each of the members of the producer node guild may receive a shard of the award. Further, each member of the production guild may have a respective shard of the producer token enabling access to the cryptographic minting factory.

In an embodiment, the disclosure provides a producer and player gaming ecosystem platform. In this example, different participants of the producer and player gaming ecosystem platform have different roles. As an example, in games, there are often deep-pocket players with capital but limited time, and b) deeply engaged players with time but limited capital. The example producer and player gaming ecosystem platform allows both sets of participants to contribute and progress in-game, while pulling forward a revenue stream for the developer. In an example implementation, players with capital but limited time passively mint and sell-in game items to players. In-game items may be hero fail-safe tokens, evolved hero fail-safe tokens, non-fungible or fungible tokens, non-divisible assets such as gear and skins. To initialize the process, a producer purchases a token production license, which enables the producer to have the rights to mint in-game items on the blockchain. Production of NFTs may be limited in supply and could be purchased by a player or collection of players (guild). Players with time but limited capital can engage with the core game loop to earn tokenized items to trade/use to upgrade hero fail-safe tokens and buy/upgrade gear and skins. In this way, the producer and player gaming ecosystem platform enables new revenue streams through the sale of “production NFTs” and revenue share in the minting of heroes, upgraded heroes, gear and upgraded gear. Transaction fees and restrictions may be implemented for sale of digital assets on the secondary market.

In an embodiment, the producer and player gaming ecosystem platform may be configured with a hero core loop that enables players to purchase new hero fail-safe tokens from producers (or from other players in the secondary market). Players can earn experience points to level up the hero fail-safe tokens via engagement such as play-to-earn participation.

In an embodiment, the producer and player gaming ecosystem platform may be configured with a hero ascension loop that enables players to earn hero shards via play-to-earn performance, such as campaign milestones and streaks. Players may trade or use hero shards to ascend (to evolve the hero fail-safe token).

In an embodiment, incentives may be provided to the first set of producers that secure a production license. Subsequent producers to secure the production license may be required to pay increased fees relative to the first set of producers. Restrictions on selling of production licenses may be in place for a limited period of time to prevent the initial set of producers from subverting and exploiting the system by selling their coveted spot in the production queue.

In an embodiment, the producer and player gaming ecosystem platform may be configured to enable players to earn gear shards via play-to-earn performance. Players may trade or use gear shards to buy/evolve gear originally minted by producers.

An example embodiment is directed to a blockchain computer system for computationally evolving digital assets and controlling digital asset transactions. The system includes a blockchain computer network configured to process transactions of digital assets and an embedded virtual machine (VM). The embedded VM is configured to decode, via a decoder, a smart contract on the blockchain computer network. The smart contract is configured to, based on at least one user activity value, computationally evolve at least one digital asset, and control, based on at least one threshold criterion, at least one transaction of a computationally evolved digital asset of the at least one digital asset on the blockchain computer network.

In an example embodiment, the smart contract may be further configured to implement a randomized mechanism for user acquisition of a digital asset of the at least one digital asset.

According to an example embodiment, the smart contract may be further configured to generate a first initial attribute value for a first digital asset of the at least one digital asset. The first initial attribute value may be equal to a second initial attribute value for a second digital asset of the at least one digital asset.

In an example embodiment, the smart contract may be further configured to generate a first exclusivity value for a first digital asset of the at least one digital asset. The first exclusivity value may be different from a second exclusivity value for a second digital asset of the at least one digital asset.

According to an example embodiment, the smart contract may be further configured to determine, based on an exclusivity value for a digital asset of the at least one digital asset, at least one attribute value threshold for the digital asset.

In an example embodiment, the smart contract may be further configured to determine, based on an exclusivity value for a digital asset of the at least one digital asset, at least one of: (i) at least one path of a computational evolution tree associated with the digital asset and (ii) a depth of the computational evolution tree.

According to an example embodiment, the at least one user activity value may include at least one of: (i) a user progress value in an electronic game platform, (ii) a user skill value in the electronic game platform, and (iii) a user performance value in the electronic game platform.

In an example embodiment, a digital asset of the at least one digital asset may have an associated computational evolution tree. The smart contract may be further configured to determine, based on the at least one user activity value, at least one path of the associated computational evolution tree. According to one such embodiment, the at least one user activity value may include a user progress value in an electronic game platform and the smart contract may be further configured to determine, based on the user progress value, a digital asset attribute level path of the associated computational evolution tree. In another such embodiment, the at least one user activity value may include a user skill value in an electronic game platform and the smart contract may be further configured to determine, based on the user skill value, a digital asset ability level path of the associated computational evolution tree. According to one such embodiment, the determined digital asset ability level path may relate to at least of one: (i) a trait of the digital asset in the electronic game platform, (ii) an item in the electronic game platform, and (iii) a skill of the digital asset in the electronic game platform. In another such embodiment, the trait of the digital asset may include a computational evolution trait digital token. According to one such embodiment, the item in the electronic game platform may include at least one of: (i) a weapon in the electronic game platform and (ii) equipment in the electronic game platform. In one such embodiment, the at least one user activity value may include a user performance value in an electronic game platform and the smart contract may be further configured to determine, based on the user skill value, a digital asset enhancement level path of the associated computational evolution tree. According to one such embodiment, the user performance value may include a performance value for an event in the electronic game platform.

According to an example embodiment, the computationally evolved digital asset may be configured to encapsulate at least one permutation of user activity values.

In an example embodiment, the at least one user activity value may include a user skill value in an electronic game platform. The smart contract may be further configured to generate, based on the user skill value, at least one computational evolution trait digital token, and process at least one transaction of the at least one computational evolution trait digital token on the blockchain computer network.

Another example embodiment is directed to a computer-implemented method for computationally evolving digital assets and controlling digital asset transactions. The method is configured to implement any embodiments or combination of embodiments described herein.

Yet another embodiment is directed to a computer program product for computationally evolving digital assets and controlling digital asset transactions. The computer program product includes a non-transitory computer-readable medium with computer code instructions stored thereon. The computer code instructions are configured, when executed by a processor, to cause an apparatus associated with the processor to implement any embodiments or combination of embodiments described herein.

An example embodiment is directed to a computer-based system for computationally evolving digital assets and controlling digital asset transactions. The system includes a blockchain computer network configured to process transactions of digital assets via a blockchain protocol. The blockchain computer network has multiple nodes. At least one blockchain computing node of the multiple nodes includes a secure cryptoprocessor implemented as a dedicated microprocessor configured to execute a VM oracle. The VM oracle is embedded on the secure cryptoprocessor. The VM oracle is configured to decode, via a decoder, a smart contract on the blockchain computer network. The smart contract is configured to, based on at least one user activity value, computationally evolve at least one digital asset, and control, based on at least one threshold criterion, at least one transaction of a computationally evolved digital asset of the at least one digital asset via the blockchain protocol.

It is noted that embodiments of the system, method, and computer program product may be configured to implement any embodiments or combination of embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a simplified block diagram of an example embodiment of a system for enforcing conditional transfer of digital assets.

FIG. 2 is a flow diagram of an example embodiment of a computer-implemented method of enforcing conditional transfer of digital assets.

FIGS. 3A-3B show example embodiments of blockchain gaming architecture and processes related to hero fail-safe tokens.

FIGS. 3C-3K show example embodiments of blockchain gaming player/producer economy and processes related to hero fail-safe tokens.

FIG. 4 is a simplified block diagram showing exemplary blockchain layers according to an embodiment.

FIG. 5 is a simplified block diagram of an example implementation of a network in communication with an embodiment.

FIG. 6 is a simplified block diagram of any internal structure of a computer/computing node in a processing environment of an embodiment.

FIG. 7A is a simplified block diagram showing an example device authentication system according to an embodiment.

FIG. 7B is a diagram showing example system components for the example device authentication system according to an embodiment.

FIG. 7C is a diagram of the example device authentication system coupled with the example system components according to an embodiment.

FIG. 7D is a diagram of the example device authentication system adaptor and its outward and inward-looking interfaces according to an embodiment.

FIG. 8A is a diagram of a sequence of packaging and delivering an instruction according to an embodiment.

FIG. 8B is a diagram of a device enrollment process according to an embodiment.

### DETAILED DESCRIPTION

A description of example embodiments follows.

In general, blockchain is a write-once, append-many type electronic ledger. Blockchain is an architecture that allows disparate users to make transactions and creates an unchangeable record of those transactions. To move anything of value over any kind of blockchain, a network of nodes must first agree that a corresponding transaction is valid. As a peer-to-peer (P2P) network, combined with a distributed time-stamping server, blockchain ledgers can be managed autonomously to exchange information between disparate parties; there is no need for an administrator. In effect, the blockchain users are the administrator.

Blockchain's rapid development has given rise to many different kinds of chains, leading to cross-chain technology. Cross-chain, as its name suggests, allows the transmission of value and information between different blockchains. According to an example embodiment, a digital asset may be exchanged, cross-chain, securely, and despite differences between constraints or rules of operation that may be established for the different blockchains. Such a digital asset may be in the form of a token, which may be fungible, or may be a non-fungible token (NFT). Such constraints or rules may be in the form of smart contracts, or other forms. Differences between such constraints or rules may include disparate levels of rigor or leniency of such constraints or rules between or among different blockchain networks.

In some embodiments, blockchain may be a peer-to-peer (P2P), electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

For a transaction to be written to the blockchain, it must be “validated.” Network nodes (miners) may perform work to ensure that each transaction is valid, with invalid transactions being rejected from the network. Software clients installed on the nodes may perform this validation work on an unspent transaction (UTXO) by executing its locking and unlocking scripts. If execution of the locking and unlocking scripts evaluates to TRUE, the transaction is valid and is written to the blockchain. Thus, for a transaction to be written to the blockchain, it should be: (i) validated by a first node that receives the transaction—e.g., if the transaction is validated, the node relays it to other nodes in the network; (ii) added to a new block built by a miner; and (iii) mined, e.g., added to the public ledger of past transactions.

Blockchain may be used for implementation of “smart contracts” that can be associated with digital assets. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets. Such assets may include real property, personal property (including both tangible and intangible property), digital assets such as software, or any other type of asset. In the digital economy, there is often an expectation that exchanges and transfers will be performed in a timely manner and across vast distances. This expectation, along with practical, technical limitations, means that traditional forms of asset transfer, such as physical delivery of hardcopy of documents representing a contract, negotiable instrument, etc., or a tangible asset itself, are not desirable. Thus, smart contracts can provide enhanced control, efficiency, and speed of transfer.

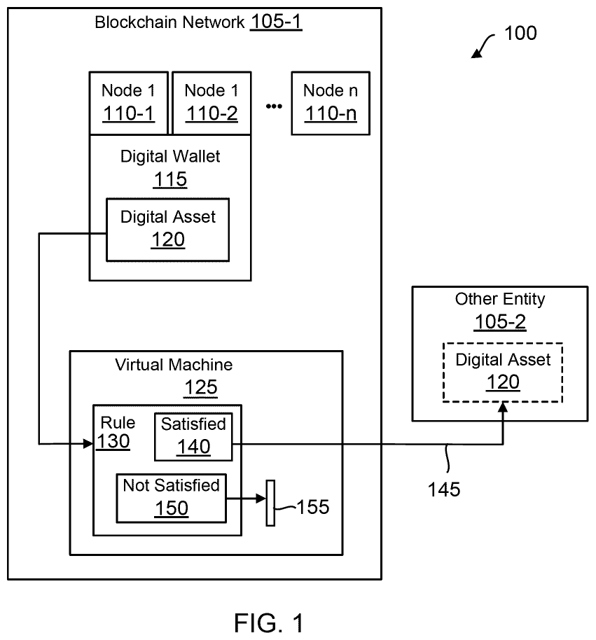

FIG. 1 is a block diagram of an example embodiment of a system 100 for enforcing conditional transfer of digital assets. The system 100 comprises a blockchain network 105-1, and another entity 105-2. Other entity 105-2 may be a second blockchain network where blockchain network 105-1 is a first blockchain network. Alternatively, other entity 105-2 may be a user of a marketplace platform, or a client device of such a user, with a location upon blockchain network 105-1 that differs from a holder of digital asset 120. In still other cases, other entity 105-2 may be a non-blockchain online entity, or even an offline entity such as a person acquainted with a holder of digital asset 120.

Continuing with respect to FIG. 1, blockchain network 105-1 includes multiple nodes 110-1, 110-2, through 110-n. It is assumed in FIG. 1 that n, the number of nodes in blockchain network 105-1, is greater than or equal to three; however, this may not always be the case, as embodiments may function with as little as two nodes 110-1, 110-2 in the multiple nodes of blockchain network 105-1, or even with a single node 110-1 instead of multiple nodes. At least a subset 110-1, 110-2 of the plurality of nodes 110-1, 110-2, through 110-n may be configured to provide digital wallet 115 enabling storage of digital asset 120 therein. It should be noted that any number of nodes less than n may comprise such a subset, and that, alternatively, all n nodes of blockchain network 105-1 may be configured to provide digital wallet 115. The digital wallet may be configured to hold the production cryptographic token enabling a producer access to the producer node minting factory. One or more of the nodes may be configured as producer nodes and/or player nodes.

To continue, upon blockchain network 105-1 is implemented virtual machine 125 configured to (i) approve 145 a transfer of digital asset 120 from a first entity to a second entity if the transfer satisfies 140 the encoded preset rule 130 associated with digital asset 120 or (ii) disapprove 155 the transfer if the transfer does not satisfy 150 rule 130. In FIG. 1, the first entity is shown to be blockchain network 105-1 and the second entity is shown to be other entity 105-2. It should be noted, however, that multiple entities affiliated with blockchain network 105-1 may be enabled to act as the first and second entities, such that a transfer of digital asset 120 occurs among entities at different network locations on the same blockchain network 105-1. Alternatively, it should be noted that the first entity may in fact be other entity 105-2, and likewise the second entity may correspond to blockchain network 105-1, such that a transfer of digital asset 120 occurs from other entity 105-2 to blockchain network 105-1, in a direction opposite to that shown in FIG. 1. As such, one of the first and second entities may be or include digital wallet 115, which may be implemented upon blockchain network 105-1, while other entity 105-2 may be implemented separately from blockchain network 105-1.

In some embodiments of system 100, rule 130 specifies a royalty to be paid to a creator or prior owner of digital asset 120 upon transfer of digital asset 120. Similar to a configuration described above, blockchain network 105-1 may be a first blockchain network, and other entity 105-2 may be implemented upon a second blockchain network. In such embodiments, the first and second blockchain networks may be respectively configured to support first and second digital asset platforms. Similar to another configuration described above, other entity 105-2 may be implemented upon blockchain network 105-1 at a network location separate from a corresponding network location of an entity embodying or including digital wallet 115. In some configurations, other entity 105-2 may be an offline entity.

In some embodiments of system 100, the multiple nodes 110-1, 110-2, through 110-n may be configured to create a hero fail-safe tokens 120. In some such embodiments, an encoded rule or condition 130 configured in the hero fail-safe token 120 may influence restrictions associated with the transfer and sale of the asset 120. The encoded rule 130 configured in the digital asset 120 may include a threshold value pertaining to evolution of digital asset 120. In some such embodiments, the encoded rule 130 configured in the digital asset 120 may implement a price floor for a transfer of digital asset 120. Alternatively, or in addition, rule 130 associated with digital asset 120 may require a price of digital asset 120 to remain within a bounded percentage of a price change from a prior transaction.

In some embodiments, blockchain network 105-1 may be decentralized. The rule 130 associated with digital asset 120 may include a smart contract. The digital asset 120 may be a non-fungible token (NFT).

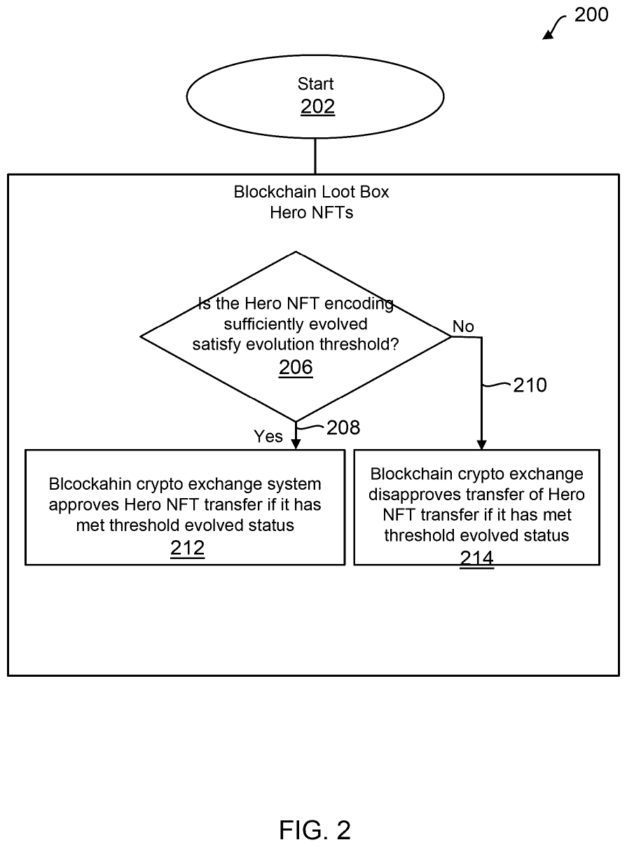

FIG. 2 is a flow diagram of an example embodiment of a computer-implemented method 200 of enforcing conditional transfer of digital assets such as hero fail-safe tokens 120. In some embodiments, method 200 starts 202 by minting the hero fail-safe token. A loot box NFT may be implemented on blockchain network 105-1 to enable game users to purchase the hero fail-safe token. The virtual machine 125 may be configured to determine 206 whether a transfer of digital asset 120 from a first entity to a second entity satisfies a preset rule 130 encoded in the smart contract of digital asset 120. For example, if the hero fail-safe token is evolved, a transfer may be permitted. In response to the transfer satisfying 208 rule 130 based on the evolution status of the hero fail-safe token, virtual machine 125 approves 212 the transfer. Alternatively, in response to the transfer not satisfying 210 rule 130, virtual machine 125 disapproves 214 the transfer. In such embodiments, one of the first and second entities is a digital wallet 115 implemented upon blockchain network 105-1, and an other 105-2 of the first and second entities is implemented apart from the blockchain network.

In some embodiments of method 200 of FIG. 2, rule 130 may be configured to specify a royalty to be paid to a creator or prior owner of digital asset 120 upon transfer of digital asset 120. The rule 130 may be further configured to implement a fractionalized royalty model that requires enforcement of a distributed royalty arrangement. In addition, blockchain network may be a first blockchain network 105-1, and the other entity may be implemented upon a second blockchain network 105-2. According to such embodiments, method 200 may further include configuring the first 105-1 and second 105-2 blockchain networks to respectively support first and second digital asset platforms.

In some embodiments of method 200, other entity 105-2 may be implemented upon blockchain network 105-1 at a network location separate from a corresponding network location of an entity embodying or including digital wallet 115. In some configurations, other entity 105-2 may be an offline entity.

In some embodiments, method 200 may include minting a hero fail-safe token 120 and establishing a threshold value pertaining to evolution metrics of the hero fail-safe token 120. A rule such as rule 130 may be configured to analyze such a threshold value. In some such embodiments, method 200 may further include implementing, via the threshold value, a transaction value floor for a transfer of hero fail-safe token 120. Alternatively, or in addition, method 200 may further include implementing a condition whereby transfer permissions associated with the hero fail-safe token 120 remains gated.

In some embodiments, method 200 may use machine learning (ML) to establish a saddle point pertaining to the evolution of hero fail-safe token 120. In this example, rule 130 may use a minimax model to compute minimum and maximum values quantifying the evolution of the hero fail-safe token to establish a saddle point (maximin). For instance, a minimax ML engine/model may be used to determine minimum and maximum values according to an evaluation function for minimizing the possible loss for a worst case (maximum loss and maximum gain) scenario associated with the token. A blockchain system, e.g., system 100, for example, may automatically and adaptively select the saddle point of hero fail-safe token 120 using a maximin model of previous set saddle points of previously evolved hero fail-safe tokens and potential ones. The model may look ahead at all possible evolution values and make a decision for the digital asset.

In some embodiments, method 200 may include minting a token with built-in security features setting conditions regarding minimum and maximum mint amount, royalties, conditions about permissible computing locations as to where the hero fail-safe token can be stored (on- or off-chain), and built-in features including randomness, rarity, and voting rights. For example, the token may be configured with custody security enabling it to be stored off-chain on a hardware security module (HSM) if it qualifies as an evolved hero fail-safe token. The HSM may create and hold private keys and secret keys securely so that they may not be extracted. The HSM may also provide an ability to perform some selected cryptographic operations with the keys.

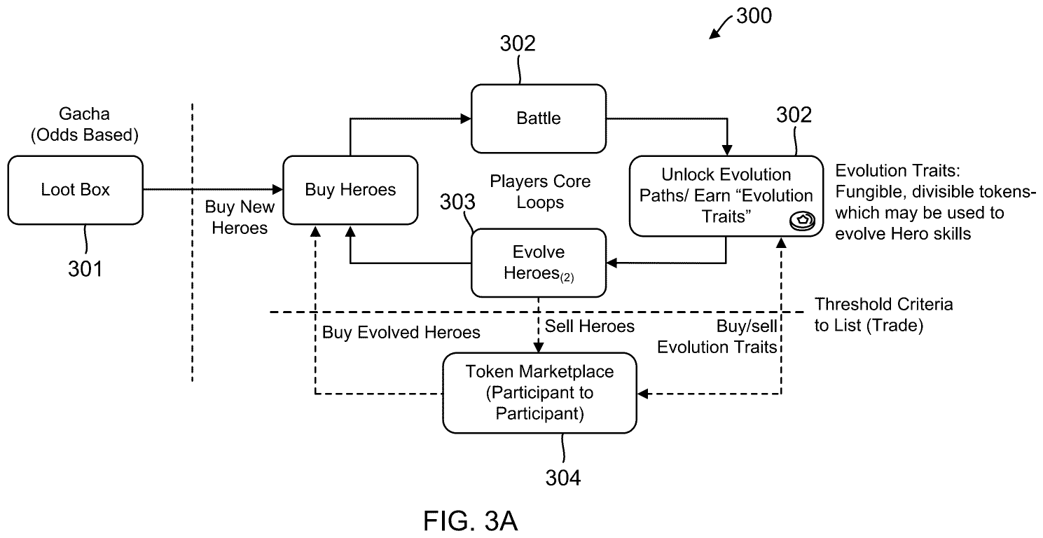

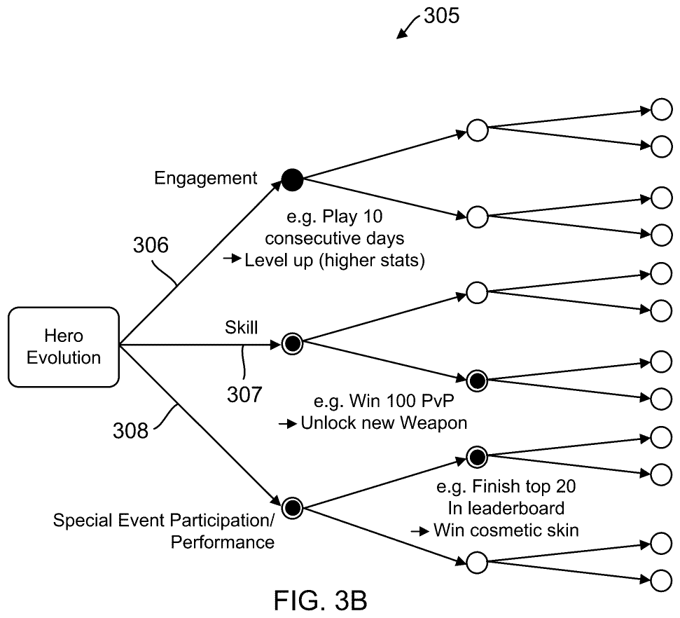

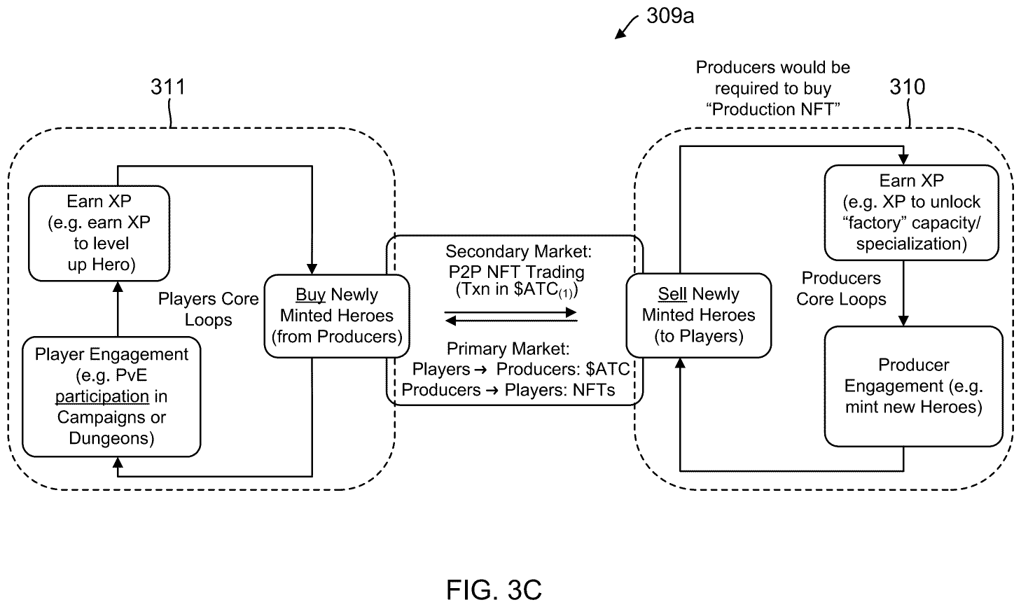

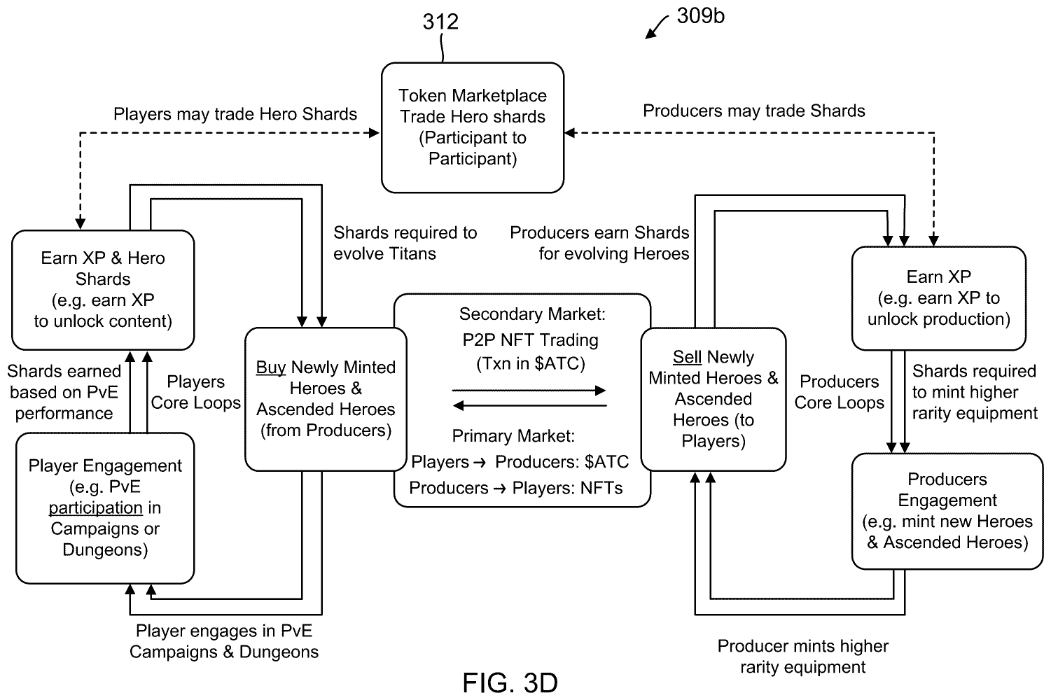

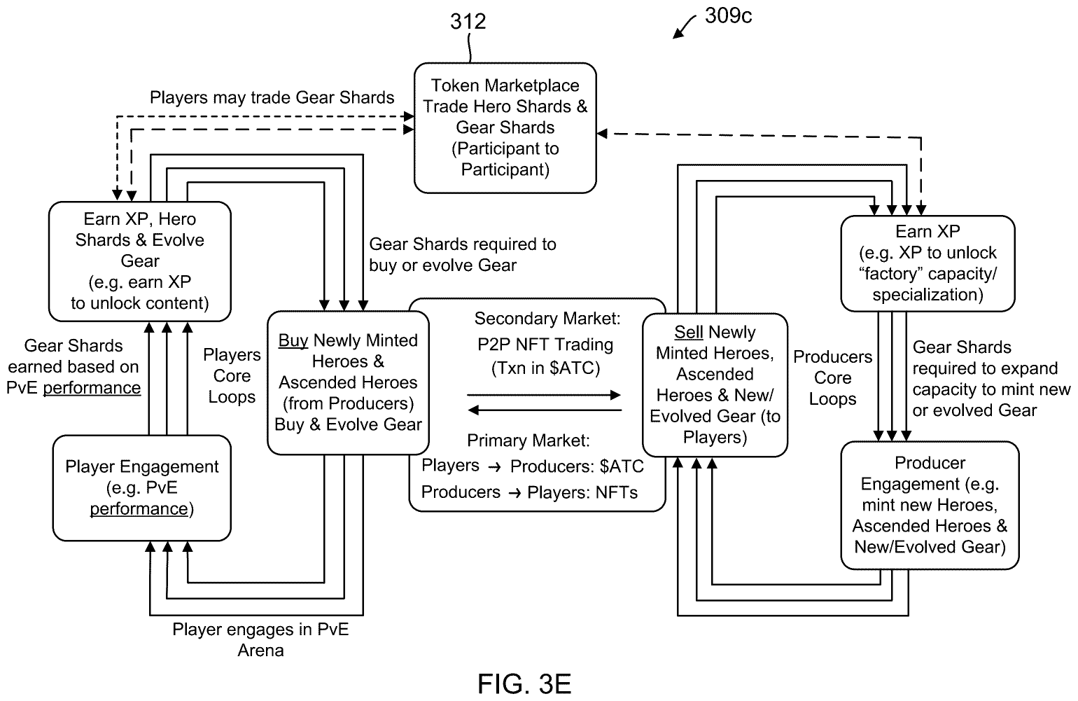

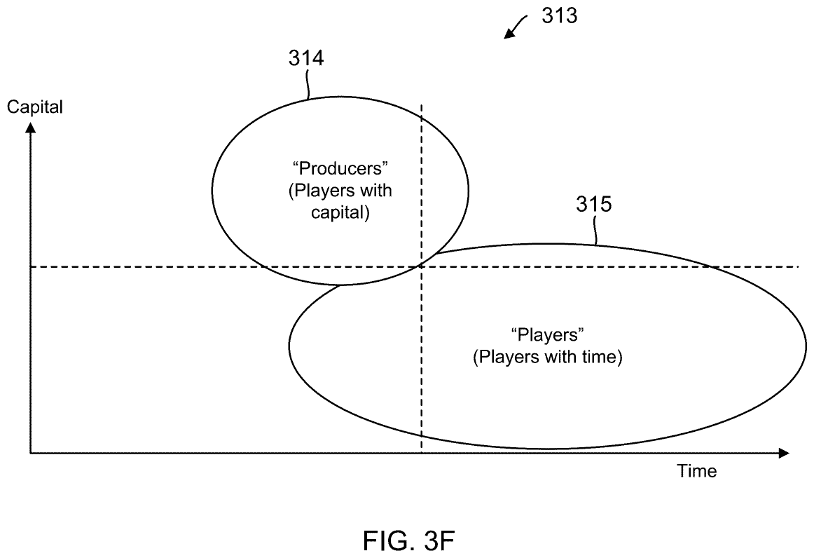

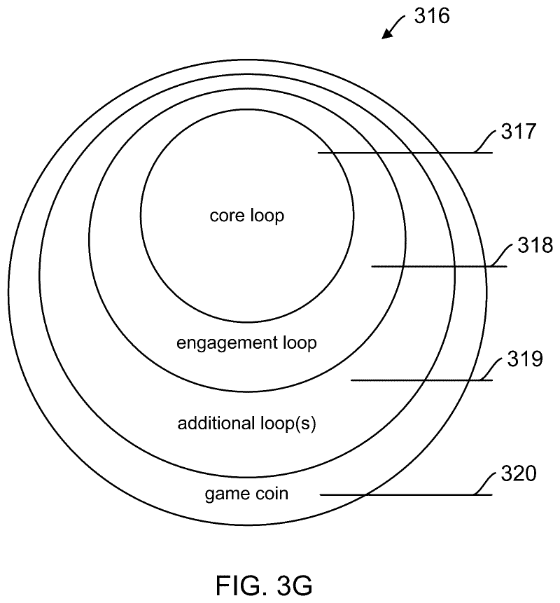

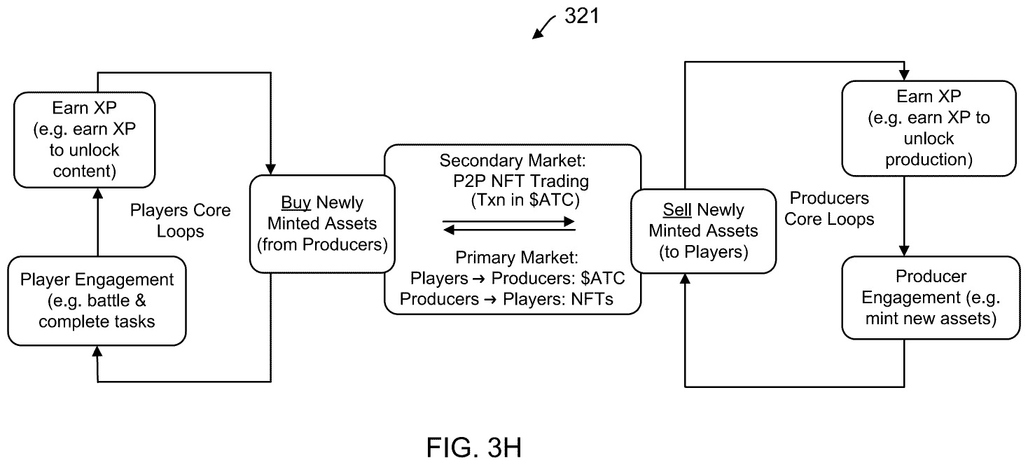

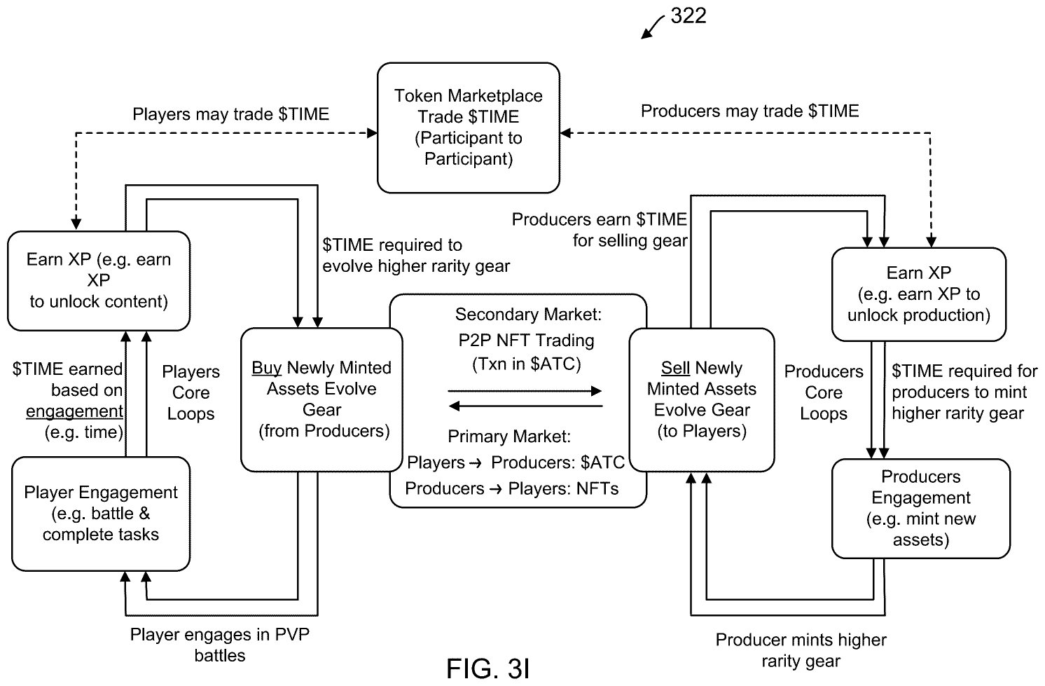

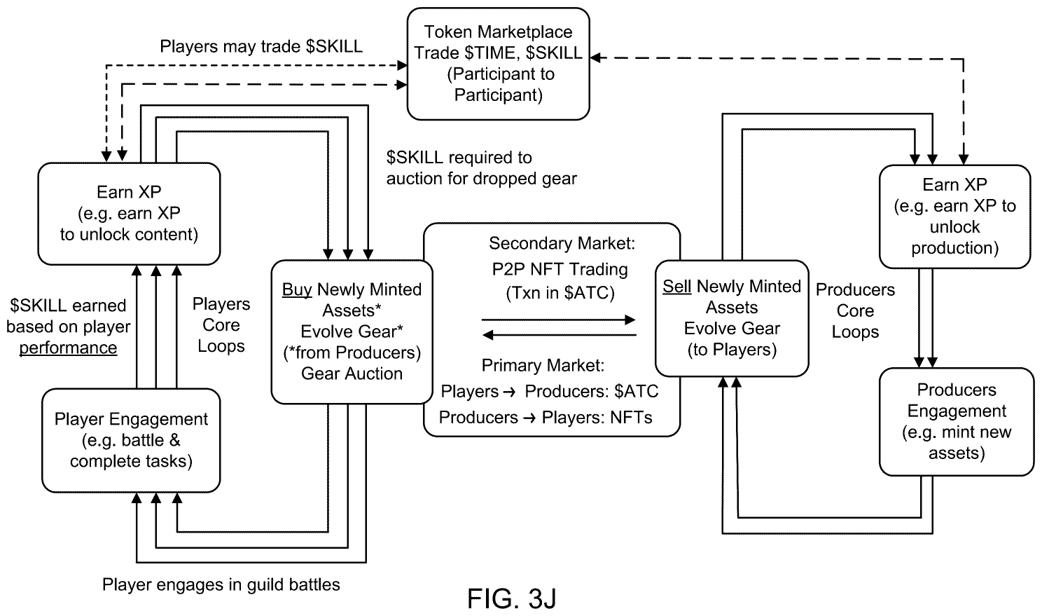

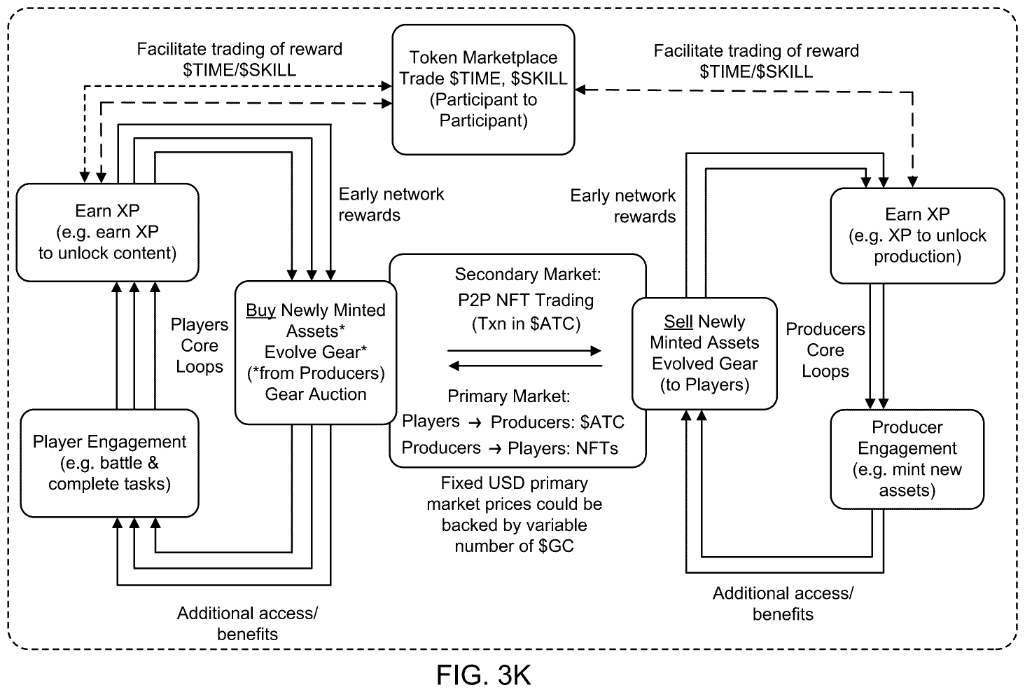

FIG. 3A shows a diagram 300 of a loot box and hero evolution loop, according to an embodiment. In this embodiment, Heroes may be purchased via a loot box 301. Once the player receives a Hero, the hero may be evolved via milestone achievements, such as experience (XP) earned while battling 302 other players, or earned traits which may be rewards for player versus player (PVP) performance. The player may also earn fungible, indivisible tokens such as hero shards from battling 302 other players. Once a player earns a predetermined amount of XP, they may unlock evolution paths or traits 303. These paths or traits 303 (i.e., the trading of tokens) may be fungible, indivisible tokens (e.g. Hero shards), which may be used to evolve 304 the Hero's skill. Players may trade or sell their Heroes on a marketplace 304, but the Hero must have been previously evolved at 303.

Because the Heroes can only be traded once they have been evolved via some milestone achievement, and actual in-game player contribution to the Hero is what makes the Hero valuable and tradeable on a secondary market, thus chance-based or luck-based tradeable Heroes are removed. For example, in an embodiment, a Hero may gain experience, special gear, or a rare skin that makes the Hero more valuable. These player contributions are not chance based or luck based, but rather engagement (e.g., time spent playing or participation in a special event) or skill based. It is only after the Hero has been evolved, or leveled up, that it may be traded on the secondary market. This way, a user cannot simply receive a Hero of great value from a loot box and trade it on the secondary market. Instead, in order to add value to a Hero, a player must invest in the gameplay.

In addition, the loot box may further reduce chance- or luck-based rewards by being transparent about the contents of the loot box by structuring the loot box as a probabilistic digital asset allocation system. For example, if the assets within the loot box have been pre-minted, players who are interacting with the loot box may be made aware of the remaining quantity and rarity of the items in the loot box. Thus, the probabilistic outcome of the player receiving, for example, a rare or common item, is presented to the user before they interact with the loot box allowing for transparency. In an embodiment, the contents of a loot box are pre-minted and the players choosing to interact with that loot box enter a queue to interact with the loot box. In this embodiment, the players would know they are in the queue, but they would not know the number of other players in the same queue, nor would they know their position in the queue. This is another way of providing transparency through the use of the loot box.

FIG. 3B shows a Hero evolution tree 305 depicting how players may evolve their Heroes based on the evolution tree progress. There are three main branches of the evolution tree, engagement 306, skill 307, and special event participation/performance 308. In the engagement branch 306, players may unlock Hero levels based on their experience (XP) or engagement streaks. For example, if a player plays for ten consecutive days, they may progress the engagement skill tree 306 and level up the Hero with higher stats. In the skill branch 307, players may unlock Hero abilities and/or equipment based on their PVP performance in the game. For example, if a player wins 100 PVP matches, they may progress the skill tree 307 and unlock a new weapon. In the special event participation/performance branch 308, players may unlock cosmetics for participating. For example, if a player finishes in the top twenty players of a battle, they may unlock a cosmetic skin for the Hero or weapon.

FIGS. 3C-3E shows an illustrative example of a “producer and player” economy design. In this illustrative example, different participants may have different roles, just as in a real economy. In games, there are often deep pocketed players with capital but with limited time, and deeply engaged players with time but limited capital. A “producer and player” economy design allows both sets of participants to contribute and progress in-game, while pulling forward cash flows for the developer. Producers, i.e., players with capital but with limited time, passively mint and sell in-game items to players. In-game items may be NFTs such as new Heroes and upgraded Heroes, or fungible, non-divisible items such as gear. To get started, the producer needs to buy a “production NFT” which may be a license to produce in-game items. The licenses to produce NFTs may be inexpensive to obtain at first, but as the producer continues to obtain production licenses they may become increasingly more expensive. Production NFTs may be limited in supply, and could be purchased by players, or a collective of players. Players, i.e., players with time but with limited capital, engage the core came loop to earn tokenized items to trade/use to upgrade Heros and to upgrade gear. This promotes more revenue streams by the sale of production NFTs, revenue share in minting of Heroes, upgraded Heroes, gear and upgraded gear. This also promotes a better proposition for developers, it brings in better cash flows earlier. The sale of “production NFTs” allows for upfront monetization of future in-game items, providing proceeds to accelerate game growth, and valuable proof points early on. This also jumpstarts the game economy. Market economy structure drives more engagement, resulting in a longer game life. This promotes more primary market activity, greater depth in secondary market trading, market-driven pricing for in-game items, and better alignment among players compared to free-to-play (F2P) games. To prevent the economy spilling over, i.e., an imbalance of players versus rewards, only the producers will be granted licenses to produce NFTs.

Referring again to FIG. 3C showing diagram 309a, this process starts with the Hero core loop. Players purchase new Heroes from producers, or from other players in the secondary market. Players earn experience (XP) to level up Heroes via engagement such as player versus enemy (PVE) participation. The Hero core loop 309a promotes the developer revenue streams via sale of production NFTs, revenue share minting of new Heroes, and secondary market transaction fees. There are two main loops, the producer core loop 310 and the player core loop 311. The producer core loop 310 involves the producers earning XP, engaging (e.g., minting new Heros), and selling the newly minted Heroes to the secondary market. The player core loop involves the players earning XP to level up their Hero, buying new Heros on the primary or secondary market, and engaging in, for example, PVE with their new Heroes to earn more XP. Because players can only obtain XP from interacting with the game, only Heros which have had time invested into them will be valuable to sell. In some embodiments, the producers may place their gear into a loot box inventory alongside similar inventory from other producers for the players to interact with.

Referring to FIG. 3D, showing diagram 309b of the Hero ascension loop. In the Hero ascension loop, players earn hero shards where they would normally earn XP though PVE performance, such as campaign milestones or winning streaks. The players trade or use Hero shards to ascend (i.e., evolve) their Heros, where ascended Heros are minted by producers. The Hero ascension loop is similar to the Hero core loop shown in FIG. 3C but contains the token marketplace 312 where players can trade Hero shards with other participants. Producers earn shards from evolving Heros, and the shards are required to mint higher rarity equipment. Once the producers mint higher rarity equipment, it can be sold to players on the secondary market. Alternatively, producers may trade shards to players in the token marketplace 312. Players purchase the Ascended Heros from the market and use those to engage in PVE campaigns and dungeons where they earn shards based on PVE performance. The Hero ascension loop allows revenue share minting of ascended Heros. Because players can only obtain shards from interacting with the game, and Producers receive shards from minting Heros, only Heros which have had time invested into them will be valuable to sell.

Referring to FIG. 3E, showing diagram 309c of the Hero gear loop. In the Hero gear loop, players earn gear shards via PVP performance and can trade or use gear shards to buy or evolve new, or evolved, gear from producers. The Hero gear loop is similar to the Hero core loop shown in FIG. 3C but contains the token marketplace 312 where players can trade gear shards with other participants. Producers earn gear shards, and the shards are required to expand capacity to mint new or evolved gear. Once the producers mint new or evolved gear, it can be sold to players on the secondary market. Alternatively, producers may trade shards to players in the token marketplace 312. Players purchase the evolved gear from the market, and use those to engage in PVP arenas where they earn gear shards based on PVE performance. The Hero gear loop allows revenue share minting of new or evolved gear.

Re-imagining a token economy means harnessing the underlying dynamics found not only in successful free-to-play (F2P) games but also existing toke projects. In F2P titles, the majority of revenue is driven by a small amount of players with capital. The top 5% of players often account for well over 50% of revenue. These players with capital often pay to not play, i.e., the spend loops are designed to accelerate progression with minimal engagement or skill.

Blockchain projects spanning games and collections have also drawn players with capital, as well as well capitalized participants. Their participation, in first generation projects, has been highly concentrated in passive activities such as staking for token rewards, speculative trading of NFTs, and creating or renting productive assets such as scholarships. FIG. 3F shows a plot 313 depicting the roles for players and producers, as a function of their capital and time. The key aspect of the core economy design is that different participants have different roles. Producers 314 are those with large amounts of capital and limited time, and players 315 are those with large amounts of time and limited capital. Producers are capital rich participants that passively mint and sell NFTs to players. The passive (regulated) production of NFTs offers a healthy way for this archetype to participate in a project, versus staking, speculation, or asset rentals. These participants are equivalent to F2P seep-spenders that pay not to play. In some embodiments, the producer loop itself may be gamified. A producer would need to buy a production NFT-the supply of which may be regulated.

FIG. 3G shows a foundational diagram 316 showing how an embodiment builds an economy from the ground up. It starts with the core loop 317 as the foundation. This is the basis on which players are introduced to ownership via NFTs, which is essential to a game economy. Each tokenized loop then encapsulates another specific aspect of player contribution, typically a tokenized engagement loop 318 for time spent in the game. Additional loops 319 can be designed to tokenize any type of contribution, such as skill, luck, or guild organization. Each loop interacts with each other to create a complex, rich economy, underpinned by an underlying tokenized game coin 320.

FIG. 3H shows a flow diagram 321 where the core economy revolves around the intersection between the player loop and the producer loop. In the core player loop players engage in-game (e.g., quests and battles) to earn XP (which unlocks content) and purchase additional assets (newly minted from the developer or from the secondary market) to progress. In the core producer loop passive “capital-rich” participants purchase production NFTs. Producers mint assets which are sold to players (for revenue), and producers earn XP which unlocks additional production capabilities (i.e., production progression).

FIG. 3I shows a flow diagram 322 where a tokenized engagement loop with a, for example, $TIME token, may be layered onto the core loop. Players earn $TIME via active engagement (e.g., time spent on PVP battles). $TIME is required to evolve higher rarity tokenized assets. Producers earn $TIME for minting (or selling) tokenized assets. $TIME is required to mint higher rarity tokenized assets.

FIG. 3J shows a flow diagram 323 where additional tokenized loops may be layered in, such as a skill loop with a $SKILL token. Players earn $SKILL tokens via their performance (e.g. guild contribution). $SKILL tokens are required to auction for dropped gear won by the guild.

FIG. 3K shows a flow diagram 324 where the entire economy is underpinned by a game coin ($GC). The $GC use cases includes a reward mechanism to bootstrap ecosystem at launch, at scale, it is a source of developer economic participation. Another $GC use case is that primary market transactions may be fixed in USD (i.e., $10 per skin) which may be denominated in a variable number of $GC. Players and producers could stake $GC for additional in-game benefits and access, $GC could also facilitate trading of $TIME and/or $SKILL.

Referring back to FIG. 1, according to an example embodiment, blockchain network 105-1 or other entity 105-2 may be an Ethereum network; however, it should be understood that blockchain network 105-1 and other entity 105-2 may be any suitable known blockchain networks. Ethereum is a decentralized network of computers with two basic functions: (i) a blockchain that can record transactions and (ii) a virtual machine (VM), that is, an Ethereum Virtual Machine (EVM), that can produce smart contracts. Because of these two functions, Ethereum is able to support decentralized applications (dApps). These dApps are built on the existing Ethereum blockchain, piggybacking off its underlying technology. In return, Ethereum charges developers for computing power in its network, which can only be paid in Ether, the only inter-platform currency. Depending on its purpose, a dApp may create ERC-20 (Ethereum Request for Comments 20) tokens to function as a currency. According to an example embodiment, fungible tokens (FTs) disclosed herein may be ERC-20 tokens or any other suitable FT known to those of skill in the art.

The code of the smart contract may be uploaded on the EVM, that may be a universal runtime compiler or browser, to execute the smart contract's code. Once the code is on the EVM, the code may be the same across each Ethereum node to be run to check whether the conditions are met, such as a condition for the balance reaching the trade value prior to expiration of the expiration term.

Ethereum has a long history of developed standards. For example, ERC-20 is a standard that defines a set of six functions that other smart contracts within the Ethereum ecosystem can understand and recognize. ERC-20 is a protocol standard and to be compliant with ERC-20, the functions need to be included in a token's smart contract. ERC-20 outlines a specific list of rules that a given Ethereum-based token must deploy, simplifying a process of programming the functions of tokens on Ethereum's blockchain. These include, for instance, how to transfer a token (by an owner or on behalf of the owner), such as may be employed for transferring fungible tokens (FTs) of a buyer, and how to access data (e.g., name, symbol, supply, balance, etc.) concerning the token, such as a value of digital asset 120 in digital wallet 115 (FIG. 1).

Alternatively, other entity 105-2 may be a non-blockchain online system or access point by which a party to a transaction involving a digital asset, e.g., digital asset 120, may connect to blockchain network 105-1. In still other cases, other entity 105-2 may be a user device other than a creator or owner of the digital asset, which transaction may thus take place in an offline manner.

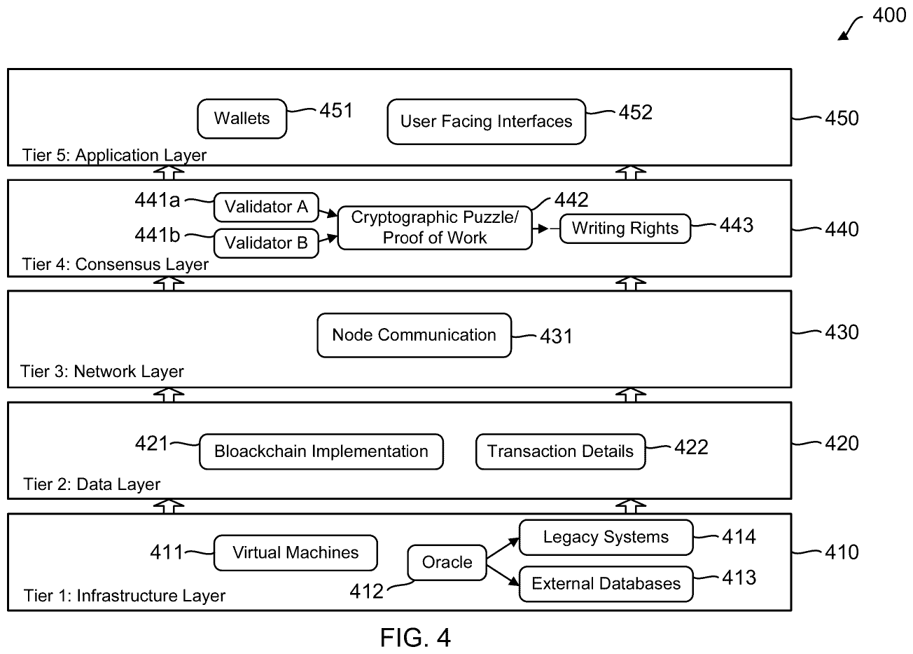

FIG. 4 is a simplified block diagram showing exemplary blockchain layers 400 according to an embodiment. Blockchain layers 400 may include infrastructure (tier 1) layer 410, data (tier 2) layer 420, network (tier 3) layer 430, consensus (tier 4) layer 440, and application (tier 5) layer 450. The infrastructure layer 410 may be a hardware layer and may include one or more virtual machines (VMs) 411 and/or one or more oracles 412. A virtual machine (VM) 411 may provide a runtime environment for transaction execution in the blockchain. In an embodiment, a VM 411 may be, for example, stack-based and may enable untrusted code to be executed by a global peer-to-peer (P2P) network of computers. An oracle 412 may provide a third-party service that connects smart contracts executing on the blockchain with off-chain data sources. For example, an oracle 412 may query, verify, and/or authenticate one or more external data sources. According to an embodiment, external data sources may include, e.g., one or more legacy systems 414 and/or one or more external databases 413.

According to an embodiment, an oracle node architecture, e.g., oracle 412, may be provided to serve machine learning (ML) models for smart contracts on a blockchain. Such an architecture may be referred to as a “ML oracle.” The ML oracle is useful to smart contract developers who want to incorporate ML models into their smart contracts. For example, a smart contract may distribute funds based on an algorithm, and the algorithm may include a ML model that forecasts sales of a product for a given week. The smart contract may invoke an inference call to a model on the ML oracle to obtain the forecast. As a further example, there are generative arts where the generative ML model may be an integral part of an artwork. Interaction with the model to generate new images may be part of a viewing experience. One well-known ML model type used by generative art is a generative adversarial network (GAN). Using the ML oracle, the ML model may become part of an NFT, thereby enabling an interactive viewing experience.

To summarize, in an embodiment, a smart contract may request an inference call to a ML model by identifying an ML model to call, such as by providing a hash value, and an input to the model. According to one such embodiment, a model file may be uploaded to, e.g., IPFS (InterPlanetary File System) or any other suitable known storage system, by a dApp developer and a model server may download the model file, e.g., using the hash value. For the ML model server to be generic enough to serve a wide range of models, it may also take as an input parameter a model type, e.g., PyTorch, TensorFlow, scikit-learn, or any other suitable known model type, as well as an input and output specification. The input may be data directly received from the calling smart contract, or it may be received indirectly via, e.g., an IPFS Uniform Resource Identifier (URI) or any other suitable identifier known to those of skill in the art. Similarly, the output may be sent back to the smart contract, or it may be uploaded to any suitable known storage system, including, but not limited to IPFS, and the, e.g., URI, may be sent to the smart contract. For example, a forecasting model may use the direct input/output method. An indirect input/output method employing a known storage system such as IPFS may be commonly used by computer vision/imaging models, among other examples.

In an example embodiment, system 100 (FIG. 1) may include a virtual machine (VM), e.g., VM 411 (FIG. 4), with a blockchain oracle, e.g., oracle 412.

Continuing with FIG. 4, data layer 420 may interface with infrastructure layer 410 and may include blockchain implementation 421 and transaction details 422. A blockchain is a decentralized, massively replicated database (distributed ledger), where transactions are arranged in blocks, and placed in a P2P network. The blockchain implementation 421 may include a data structure represented, for example, as a linked list of blocks, where transactions are ordered. The blockchain implementation 421's data structure may include two primary components-pointers and a linked list. Pointers are variables that refer to a location of another variable, and a linked list is a list of chained blocks, where each block has data and pointers to the previous block. Each block may contain a list of transactions that happened since a prior block. Transaction details 422 may contain information about transactions occurring on the blockchain.

The network layer 430 may interface with data layer 420 and may also be referred to as a P2P layer or propagation layer. One purpose of network layer 430 may be to facilitate node communication 431, such that nodes can discover each other and can communicate, propagate, and synchronize with each other to maintain a valid current state of the blockchain. A distributed P2P network, e.g., network layer 430, may be a computer network in which nodes are distributed and share the workload of the network to achieve a common purpose. Nodes in network layer 430 may carry out the blockchain's transactions.

The consensus layer 440 may interface with network layer 430 and may ensure that blocks are ordered, validated, and guaranteed to be in the correct sequence. A set of agreements between nodes in a distributed P2P network may be established by the consensus layer 440. The agreements result in consensus protocols or algorithms, which correspond to rules that nodes follow in order to validate transactions and create blocks in accordance with those rules. To validate a transaction, a validator, e.g., validator 441a or validator 441b, may perform a consensus algorithm, such as proof of work 442 or any other suitable algorithm known in the art. Performing the consensus algorithm may involve expending computational resources to solve a cryptographic puzzle 442. After being validated according to a consensus algorithm, a transaction may be written to the blockchain through a process of writing rights 443.

The application layer 450 may interface with consensus layer 440 and may include customized applications and services, such as electronic wallets 451. Further, application layer 450 may include (not shown): smart contracts, chaincode, and decentralized apps (dApps). The application layer 450 may also include applications utilized by end users to interact with the blockchain. Such applications may be, e.g., one or more user facing interfaces 452. Further, such applications may include, for example (not shown): scripts, application programming interfaces (APIs), and frameworks.

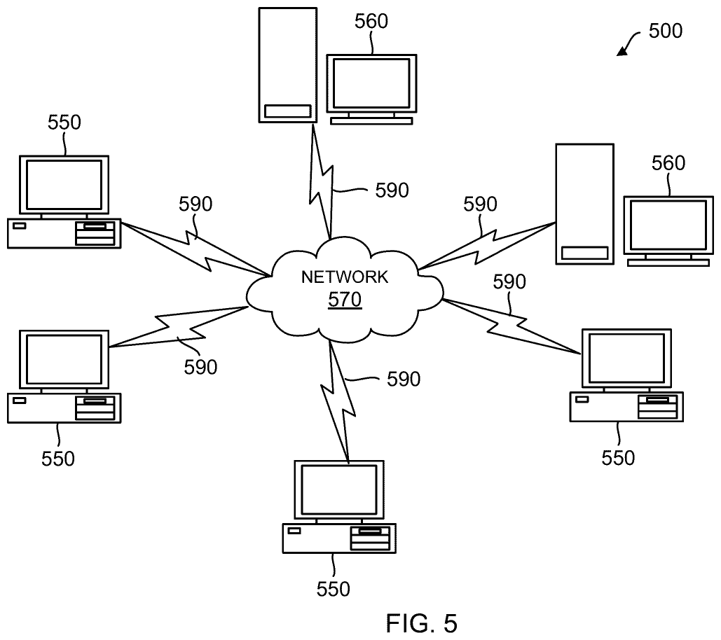

An example implementation of system 100 (FIG. 1) may be implemented in a software, firmware, or hardware environment. FIG. 5 illustrates one such example digital processing environment 500 in which embodiments of system 100 may be implemented. Client computer(s)/device(s) 550 and server computer(s)/device(s) 560 provide processing, storage, and input/output (I/O) devices executing application programs and the like.

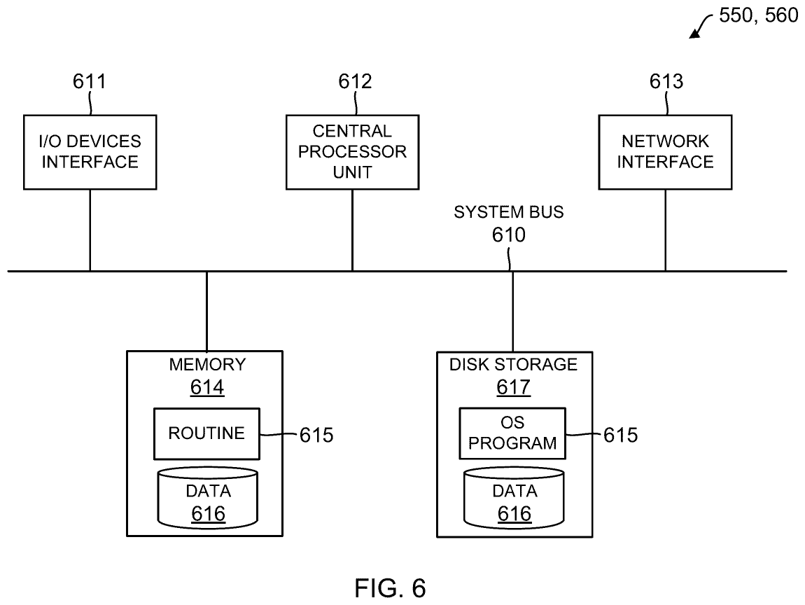

Client computer(s)/device(s) 550 may be linked 590 directly or through communications network 570 to other computing devices, including other client computer(s)/device(s) 550 and server computer(s)/device(s) 560. Referring to FIGS. 5 and 6 (the latter described in more detail hereinbelow), network 570 utilizes system 100 according to an embodiment of the invention, for enforcing conditional transfer of digital assets, e.g., digital asset 120 (FIG. 1).

The communication network 570 may be part of a wireless or wired network, a remote access network, a global network (e.g., the Internet), a worldwide collection of computers, local area networks (LANs) or wide area networks (WANs), and gateways, routers, and switches that may use a variety of known protocols (e.g., TCP/IP, Bluetooth®, etc.) to communicate with one another. Communication network 570 may also be a virtual private network (VPN) or an out-of-band (OOB) network or both. Further, communication network 570 may take a variety of forms, including, but not limited to, a blockchain network, a distributed ledger network, a data network, voice network (e.g., landline, mobile, etc.), audio network, video network, satellite network, radio network, and pager network. Other known electronic device/computer network architectures are also suitable. For example, client computer(s)/device(s) 550 may include nodes shown in FIG. 3, which run user applications that enable a user to communicate with an application to determine whether a user meets a work requirement. A blockchain network, such as blockchain network 105-1 (FIG. 1), may be configured on each user device 310, 320 (FIG. 3) to store tokens. Client computers 350 (FIG. 3) of the computer-implemented system 100 (FIG. 1) may be configured with a trusted execution environment (TEE) or trusted platform module (TPM), where the application may be run and digital assets, e.g., digital asset 120, and/or tokens may be stored.

Referring again to FIG. 5, server computer(s)/device(s) 560 of the computer-implemented system may be configured to include a server that that executes the application. For example, the application of server computer(s)/device(s) 560 may determine whether a user has satisfied a work requirement and produce a determination result and pair, in computer memory, e.g., memory 614 (FIG. 6), an indication of the determination result with an identifier of the user or an identifier of a digital asset of the user, such as an address of a node of a blockchain network accessible by the user. The application of server computer(s)/device(s) 560 also facilitates a transfer of a collateral token by moving the collateral token to, for example, a digital wallet, e.g., digital wallet 115 (FIG. 1), implemented upon a blockchain network. For another example, server computer(s)/device(s) 560 or client computer(s)/device(s) 550 may comprise peer computing devices (nodes) 310, 320, 330, 340, 350, 360 of a distributed blockchain ledger 300 of FIG. 3, which use smart contracts to execute and record transactions implemented via tokens.

FIG. 6 is a block diagram of any internal structure of a computing/processing node (e.g., client computer(s)/device(s) 550 or server computer(s)/device(s) 560) in the processing environment 500 of FIG. 5, which may be used to facilitate displaying audio, image, video, or data signal information. Each computer/device 550, 560 in FIG. 6 may contain a system bus 610, where a bus is a set of actual or virtual hardware lines used for data transfer among components of a computer or processing system. System bus 610 may essentially be a shared conduit that connects different elements of a computer system (e.g., processor, disk storage, memory, I/O ports, etc.), thereby enabling transfer of data between elements or components.

Continuing with FIG. 6, attached to system bus 610 is an I/O device interface 611 for connecting various input and output devices (e.g., keyboard, mouse, touch screen interface, displays, printers, speakers, audio inputs and outputs, video inputs and outputs, microphone jacks, etc.) to a computer/device 550, 560. Network interface 613 may allow a computer/device to connect to various other devices attached to a network, for example network 570 of FIG. 5. Memory 614 may provide volatile storage for computer software instructions 615 and data 616 used in some embodiments to implement software modules/components of system 100 (FIG. 1).

Software components 615, 616 of system 100 (e.g., virtual machine 704, a minimax recursive algorithm, encoder/decoder, Trusted Execution Environment (TEE), blockchain layer 1 virtual machine (VM), oracle, wallet interface, applets, authentication site, cybersecurity controller, service applications, and the like) described herein may be configured using any programming language known in the art, including any high-level, object-oriented programming (OOP) language, such as Python or Solidity. The computer-implemented system may include instances of processes that enable execution of transactions and recordation of transactions. It should be understood that the terms “transaction” and “exchange” are herein used interchangeably, when used within a context of digitally transferring items of value, such as digital assets (e.g., digital asset 120 (FIG. 1)), collateral assets, and/or collateral tokens, among entities associated with a blockchain network, e.g., blockchain network 105-1 (FIG. 1). The computer-implemented system 100 may also include instances of encoders/decoders, which can be implemented by, e.g., a server 560 or a client that communicates with the server 560, using, for example, secure sockets layer (SSL), Hypertext Transfer Protocol Secure (HTTPS), or any other suitable protocol known to those of skill in the art.

In an example mobile implementation, a mobile agent implementation of embodiments may be provided. A client-server environment may be used to enable mobile services using a network server, e.g., server 560. It may use, for example, the Extensible Messaging and Presence Protocol (XMPP) protocol, or any other suitable protocol known to those of skill in the art, to tether an engine/agent 615 on a user device 550 to a server 560. The server 560 may then issue commands to the user device on request. The mobile user interface framework to access certain components of computer-implemented system 100 (FIG. 1) may be based on, e.g., XHP, Javalin, and/or Wireless Universal Resource FiLe (WURFL), or other suitable known framework(s), interface(s), or combinations thereof. In another example mobile implementation for the iOS operating system (OS) and its corresponding application programming interface (API), the Cocoa Touch API may be used to implement the client-side components 615 using Objective-C or any other suitable known high-level OOP language that adds Smalltalk-style messaging to the C programming language.

Disk storage 617 may provide non-volatile storage for computer software instructions 615 (equivalently “OS program”) and data 616 may be used to implement embodiments of system 100. The system may include disk storage accessible to a server computer 560. The server computer may maintain secure access to records associated with system 100. Central processing unit (CPU) 612 may also be attached to system bus 610 and provide for execution of computer instructions. In one example embodiment, the CPU 612 is a secure cryptoprocessor implemented as a dedicated microprocessor configured to execute the virtual machine. The cryptoprocessor may be specialized to execute cryptographic algorithms within hardware to support the virtual machine. Functions include such things as accelerating encryption algorithms that verify compliance of encoded rules related to an NFT asset, enhanced tamper, and intrusion detection, enhanced data, key protection and security enhanced memory access and I/O to facilitate transactions across multiple blockchain systems.

In some embodiments, processor routines 615 and data 616 may be computer program products. For example, aspects of system 100 may include both server-side and client-side components.

In other embodiments, authenticators/attesters may be contacted via, e.g., blockchain gaming systems, instant messaging applications, video conferencing systems, VolP (voice over IP) systems, etc., all of which may be implemented, at least in part, in software 615, 616. Further, in yet other embodiments, client-side components interfacing with system 100 may be implemented as an application programming interface (API), executable software component, or integrated component of the OS configured to provide access to an electronic wallet on a Trusted Platform Module (TPM) executing on a client device 550.

In one embodiment, the virtual machine is implemented as an embedded virtual machine, preferably executing on one or more cryptoprocessors configured to support efficient and scalable processing of application-to-blockchain and blockchain-to-blockchain transactions. The cryptoprocessor may be a dedicated computer-on-a-chip or microprocessor for carrying out cryptographic transaction operations, embedded in a hardware security module with security measures providing fail-safe tamper resistance. The embedded cryptographic processor can be configured to output decrypted data onto a bus in a secure environment, in that embedded cryptoprocessor does not output decrypted data or decrypted program instructions in an environment where security cannot be maintained. The embedded cryptoprocessor does not reveal keys or executable instructions on a bus, except in encrypted form, and zeros keys by attempts at probing or scanning.

In an embodiment, software implementations 615, 616 may be implemented as a computer-readable medium capable of being stored on a storage device 617, which provides at least a portion of the software instructions for system 100. Executing instances of respective software components of system 100, such as instances of system 100, may be implemented as computer program products 615, and may be installed by any suitable software installation procedure, as is well known in the art. In another embodiment, at least a portion of the system software instructions 615 may be downloaded over a wired and/or wireless connection via, for example, a browser SSL session or through an app (whether executed from a mobile or other computing device). In other embodiments, system 100 software components 615 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s) known in the art).

In one embodiment, the virtual machine is implemented as an embedded virtual machine, preferably executing on one or more cryptoprocessors configured to support efficient and scalable processing of application-to-blockchain and blockchain-to-blockchain transactions. The cryptoprocessor may be a dedicated computer-on-a-chip or microprocessor for carrying out cryptographic transaction operations, embedded in a hardware security module (HSM) with security measures providing fail-safe tamper resistance. The embedded cryptographic processor can be configured to output decrypted data onto a bus in a secure environment, in that embedded cryptoprocessor does not output decrypted data or decrypted program instructions in an environment where security cannot be maintained. The embedded cryptoprocessor does not reveal keys or executable instructions on a bus, except in encrypted form, and zeros keys by attempts at probing or scanning.

An example embodiment includes device code executed in a TEE or TPM. A TEE or TPM is a hardware environment that runs instructions and stores data outside a main operating system (OS) of a device. This protects sensitive code and data from malware or snooping with purpose-built hardware governed by an ecosystem of endorsements, beginning with a device manufacturer. The system may perform checks on the TEE or TPM, such as executing BIOS (Basic Input/Output System) checks, to verify that folders (e.g., wallets, such as digital wallet 115 (FIG. 1)) stored in the TEE/TPM have not been altered by malicious actors.

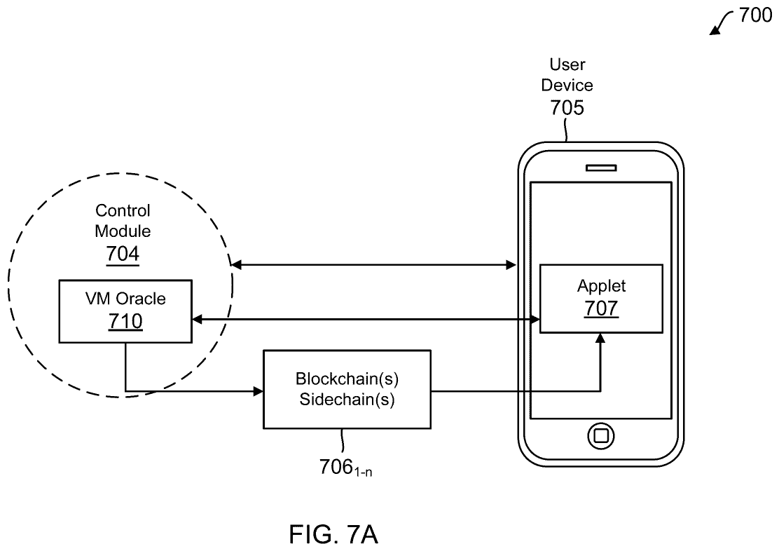

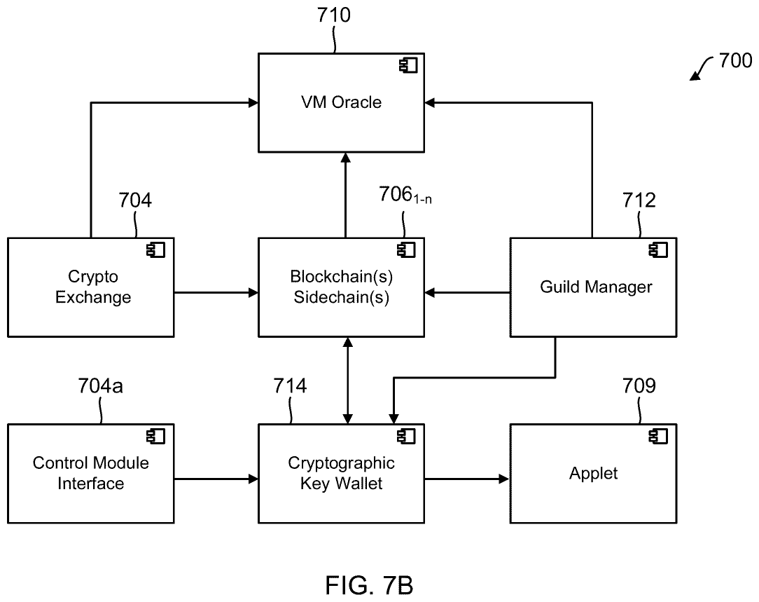

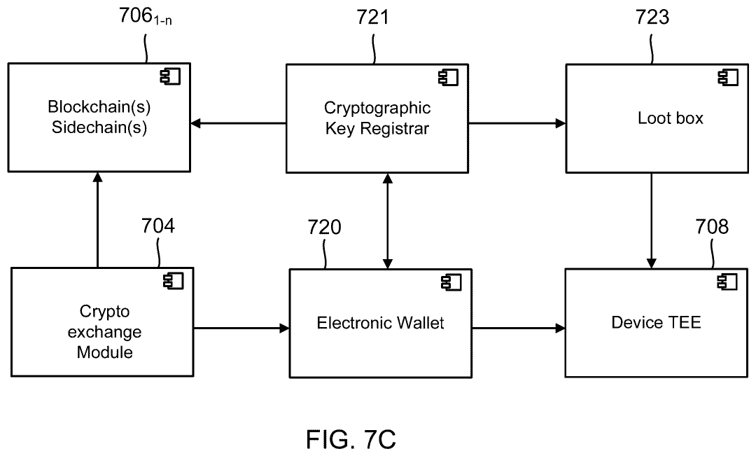

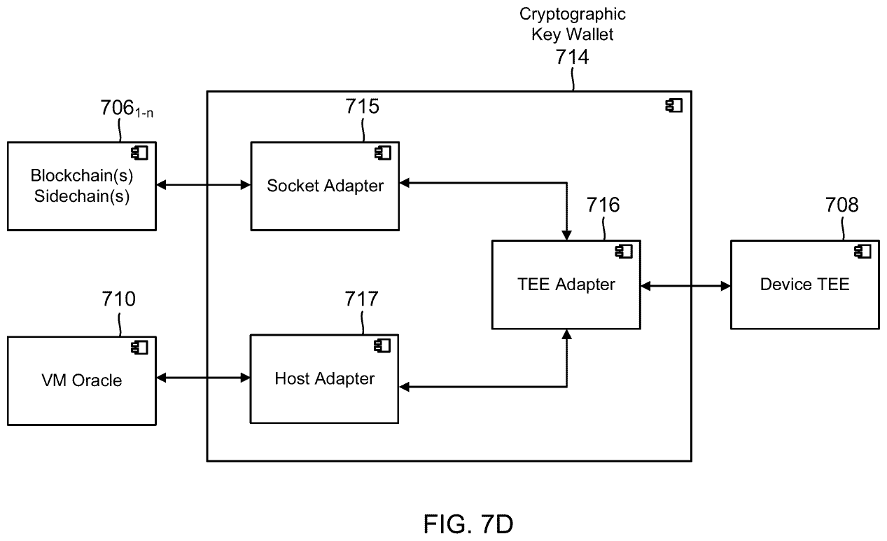

FIG. 7A is a simplified block diagram showing an example device authentication system 700 with components upon which system 100 (FIG. 1) may operate according to an embodiment. With these system components 700, network nodes may make use of hardened encryption and the cryptographic key in endpoint user devices 705 through an API 704a to a virtual machine. The user devices 705 may provide processing, storage, and input/output devices executing application programs and the like. In addition, further services may be provided built on these system components 700 for device management, backup, attestation, etc. To support system 100, the registration of identity cryptographic keys and a set of device management services for attestation, backup, and device grouping, are managed. The system components 700, e.g., cryptographic key wallet 714, may also interface with applet 709.

It would be the intent of system 700 not to maintain mission critical data as in conventional approaches, but rather to provide a platform for seamless, yet secure, connections between virtual machine 704 and user devices 705. On one end of the system is the VM oracle 710 that prepares an instruction for a user device 705 and at the other is system 700 which is applet 707 that can act on that instruction. A protocol may define how these instructions and replies are constructed.

According to an embodiment, system 700 may illustrate binding between the digital asset and multiple parties/devices. The system 700 may lock features of identity, transaction and attestation to the hardware of respective user devices 705.

In an embodiment, system 700, shown in FIG. 7B, may use a secure socket, e.g., SSL or HTTPS, to maintain a persistent connection with devices. This channel is used for pairing and other administrative functions. VM oracle 710 may be provided to/utilized on blockchain networks for simplifying the encoding of a transaction. This VM oracle 710, for example, could be implemented in a programming language, such as a high-level, OOP language with dynamic semantics like Python.

A TEE may be implemented in a user device hardware security chip separate execution environment that runs alongside the rich operating system, and provides security services to that rich environment. The cryptographic keys and/or digital assets, collateral assets, or collateral tokens may be stored in the TEE. The TEE offers an execution space that provides a higher level of security than a rich OS. The TEE may be implemented as a virtual machine (VM), on the user devices, or on the network nodes.

The guilds manager 712 can be implemented as a service provided to end-users for managing guilds of players 705. User devices 705 may be grouped into a single identity and used to backup and endorse each other. Guilds may be associated with other guilds to create a network of guilds. The guilds may be configured using a collection of individual device cryptographic public keys (as opposed to a new key). If there are not many shared devices in the network, the list of devices may be short because of the potential for increased computational and bandwidth resources that may expended, and may introduce a time cost for encrypting a transaction with all cryptographic keys on a device list.

In an example embodiment, the device TEE 708 is a software program that executes in a hardware secured TEE. The device TEE 708 is specially designed to execute cryptographic functions without compromise from malware or even the device operator.

The blockchain loot box 723 may be implemented as a smart contract executing from the blockchain and configured to authorize to cryptographically approval of a transfer of the hero fail-safe token.

In a trusted computing embodiment, when the electronic wallet 720 shown in FIG. 7C runs for the first time to process an NFT, it will ask the device TEE 708 to generate the cryptographic key. Each digital asset is signed by the node that deposits the asset into a locker with their signature and is thereby locked. For a node to then interact with the asset on the network on which it is locked, the node must unlock the asset with a cryptographic signature. Registration may involve confirmation from the device operator. The registrar may ask the device for a Device Measurement Record which includes one or more of the following: a composite value of the Platform Configuration Registers (PCRs) generated by the boot process, BIOS version, OS version, GPS (Global Positioning System) location, among other examples. This data may be signed by the cryptographic key. It may be further signed by the registrar. The resulting data set may become the gold reference or reference value for future integrity checks. Confirmation from the device operator may be required in collecting the gold reference or reference value. This data set may be posted into a public cryptographic ledger. The public record may establish cryptographic proof of the time of registration along with the endorsement of the registrar. The registration may further include attribute data, such as location or company name or device make/model. The registration may reference a signed document that sets out the policy terms of the registrar at the time of registration. The cryptographic key registrar 721, or another trusted integrity server, may create a blockchain account key (a public/private key pair) that can be referenced as a signatory in a multi-signature transaction on the blockchain. A signatory may indicate that the value represented in the blockchain transaction cannot be spent or transferred unless co-signed by the registrar.

The blockchain(s)/sidechain(s) 706₁₋ₙ may be a JSON (JavaScript Object Notation) API written in Python, which uses the third-party agent/process private key to enroll the identity cryptographic keys of devices 705 and system 700. During enrollment, the public key of the user device 705 or system 700 is recorded by the TEE applet 708. Enrollment enables the TEE applet 708 to pair a device 705 with virtual machine 704. In one embodiment, the result of pairing is that a user device 705 has a service public key, endorsed by a third-party agent/process and can therefore respond to virtual machine instructions and approve transfer of the hero fail-safe token.

In an embodiment, the cryptographic key wallet 714 of FIG. 7B may be composed of outward and inward-looking interfaces as shown in FIG. 7D. The inward-looking interface, the TEE adapter 716, handles proprietary communications with system 700. The host adaptor 717 is provided to expose services to third-party applications. The host adaptor 717 may present the interface of the cryptographic key wallet 714 through different local contexts, such as browsers or system services. Multiple realizations for diverse contexts are anticipated. The socket adaptor 715 may connect the client environment blockchain(s)/sidechain(s) 706₁₋ₙ. The TEE adaptor 716 may be the glue that pipes commands into system 700. The cryptographic key wallet 714 may prepare message buffers that are piped to system 700, and then synchronously awaits notification of a response event. The host adaptor 717 may isolate the TEE adapter 716 from the host environment. The host adaptor 717, in an embodiment, may operate in a potentially hostile environment. The host adaptor 717's role may be to facilitate easy access to the system 700. Instructions from a virtual machine 704 intended for system 700 may be signed by virtual machine 704 and then passed through to the TEE adapter 716 and system 700.

The blockchain(s)/sidechain(s) 706₁₋ₙ may have a special capability of being able to pair additional instances of virtual machines with device 705. Communications with the first blockchain(s)/sidechain(s) 706₁₋ₙ may be handled through the web API and preferably are authenticated. In one example, this is implemented with an API key. This may be implemented using an SSL key swap. In some embodiments, all requests are signed.

The system 700 provides robust security. The digital locker may be used to make it more difficult for an attacker to access the digital asset in the digital asset locker, as, if the attacker does not possess a valid cryptographic key, access to the locker will not be validated. Furthermore, system 700 may preferably be in near constant contact with all devices 705 through the socket adapter 715 shown in FIG. 7C.

In an embodiment, blockchain(s)/sidechain(s) 706₁₋ₙ may comprise several sub-components. For example, each block on the blockchain(s)/sidechain(s) 706₁₋ₙ may contain hashes, a height, nonce value, confirmations, and/or a Merkle Root, among other examples.

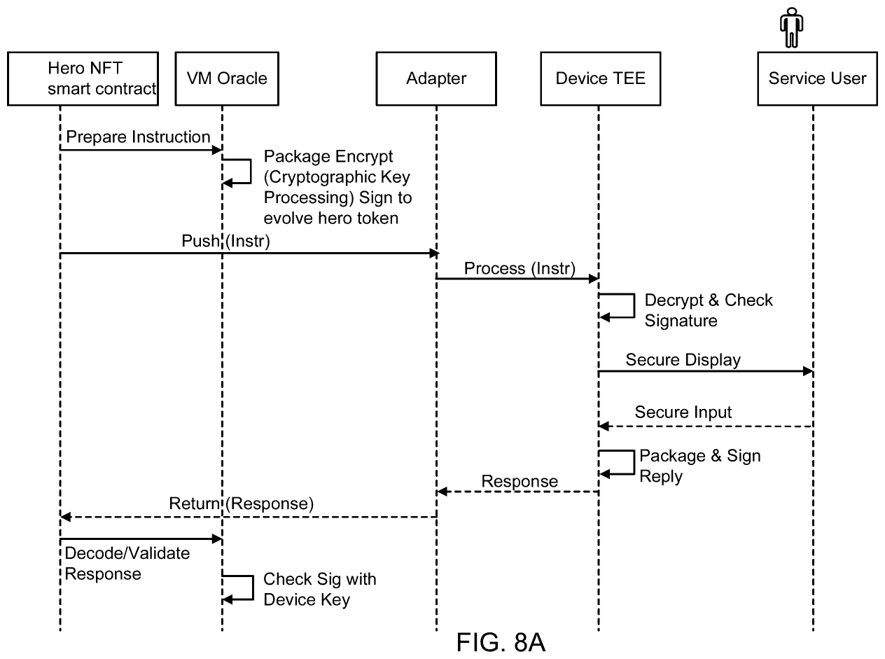

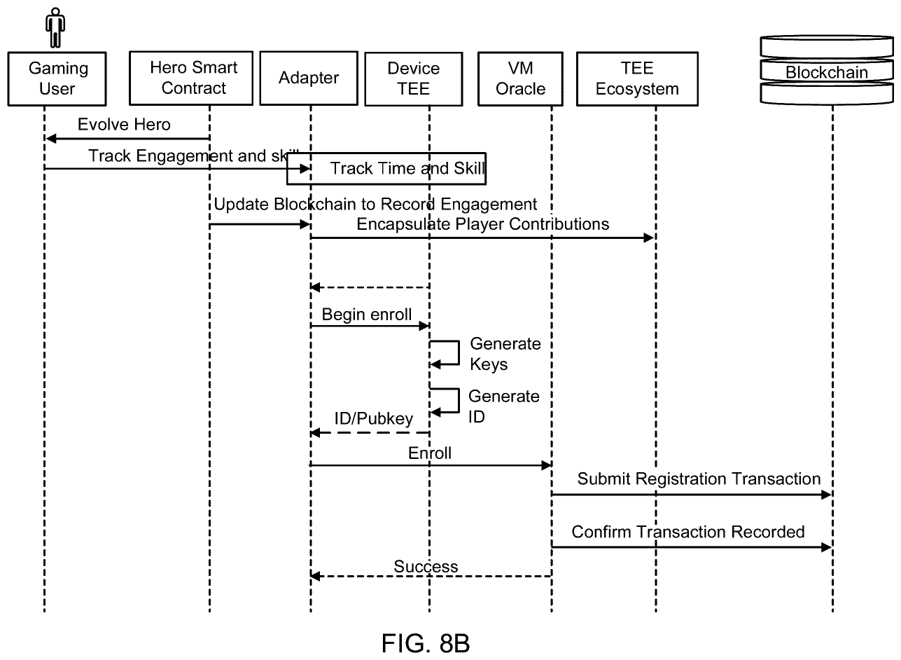

In an embodiment, a sequence of packaging and delivering an instruction is shown in FIG. 8A. The virtual machine 704 may generate an instruction record with the help of the VM oracle 710 libraries. The instruction may include the type, the target device, and payload. The instruction may be encoded with one or more cryptographic keys. The cryptographic key is fetched from the blockchain(s)/sidechain(s) 706₁₋ₙ, by looking up the device registration record.

In an embodiment, device enrollment may be performed. An example enrollment process, shown in FIG. 8B, should be hassle free, or even transparent to the user. This embodiment may ensure that system 700 is operating in a proper TEE.

FIG. 9 shows an example of a user identification system 900 according to an embodiment. A user 915 interacts via user input 920 with a website displayed via a web browser 910 running on computing device 905, such as clicking an advertisement on the displayed website. The interaction is communicated to server (token server) 935. For example, a transparent pixel or script may be placed on the displayed website to communicate the interaction to the server 935.

An application executing on the server 935 determines whether the user 915 is a software robot or a person user by issuing a request 925 to web browser 910 to produce a token. The request 925 is sent over a network 245. In response to request 925, web browser 910 produces a token 930 on computing device 905. The token 930 is sent to the server 935 over network 945. The application executing on server 935 determines (e.g., using a computational challenge) a computational cost of producing the token 930. In some embodiments, the computational cost of producing the token 930 is based on the time taken to produce the token 930. Based on the computational cost of producing the token 930, the application on server 935 determines (deciphers) whether the user 915 is a software robot or a person user. In some embodiments, proving the computational cost of producing the token 930 at the computing device 905 is performed by an independent third party, rather than the application executing on server 935.

An application that determines whether the user 915 is software robot or a person user may also exist locally on the computing device 905. In this embodiment, it would not be necessary to send request 925 or token 930 over a network 945.

In some embodiments, the request 925 is issued in response to particular user engagement in the web browser 910 and based on user engagement metrics, including mouse movements by the user. The request 925 can also be issued in response to an elapsed period of time or issued by a web service.

In some embodiments the application on server 935 of FIG. 9 calculates a confidence score and metrics associated with whether the user 915 operating computing device 905 is at least in part by a software robot or a person user. Once the application on server 935 determines whether user 915 is a software robot or a person user, the application on server 935 returns the identity of the user 940 and a calculated confidence score, which is associated with a likelihood of whether computing device 905 is being operated by a software robot or a person user. Thus, the calculated confidence score indicates a confidence value regarding the user identification. The confidence score helps the relying party determine a measure of confidence about the identity of the user 940.

The confidence score can be based on many different factors. One factor is the computational cost of the produced token 930. If the proven computation cost is low (below a threshold value), the confidence score may be increased. Further, if computing device 905 is a server, the computational cost is higher than if the computing device 905 is an individual machine, and thus the confidence score may be increased. The confidence score may be based on the time it took computing device 905 to produce the token 930. For example, longer times (e.g., above a time threshold) for producing token 930 may be associated with a higher likelihood that the identity of the user 940 is a software robot and a lower likelihood that the identity of the user 940 is a person user. In another embodiment, the confidence score is increased if the computing device 905 includes a TPM (Trusted Platform Module).

According to some embodiments, produced token 930 is captured in a cookie. In an embodiment, the captured produced token and the computational cost of the captured produced token 930 are time sensitive and expire after a period of time. Captured cookies can sign cookies generated in the future thus, building up proof of whether the web browser 910 running on computing device 905 is being operated by a person user or a bot. The building up of proof results in a longer block chain, making it increasingly difficult for a web browser running on a machine that is operated by a bot to continue to produce tokens.

In some embodiments, the confidence score may be calculated to further consider the confirmed purchase activities of the user. The score may increase when determined that a user is a verified purchaser who previously completed an online purchase. The proof of a user being an online purchaser, such as a retrieved proof of purchase cookie associating the user's identity to an entry in a database of confirmed purchases may increase the confidence score. For example, a retrieved proof of purchase cookie associating the user's identity particularly to a persistent entry in a block chain database of confirmed purchases may further increase the confidence score. That is, the trusted confirmation of the user as a verified purchaser may be associated with a higher likelihood (confidence) that the identity of the user is a person (rather than a software robot).

Further example embodiments disclosed herein may be configured using a computer program product; for example, controls may be programmed in software for implementing example embodiments. Further example embodiments may include a non-transitory computer-readable medium containing instructions that may be executed by a processor which, when loaded and executed, cause the processor to complete methods described herein. It should be understood that elements of the block and flow diagrams may be implemented in software or hardware, such as via one or more arrangements of circuitry of FIG. 6, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer-readable medium, such as random-access memory (RAM), read-only memory (ROM), compact disk read-only memory (CD-ROM), and so forth. In operation, a general-purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

It should be understood that the term “blockchain” as used herein includes all forms of electronic, computer-based distributed ledgers. These include consensus-based blockchain and transaction-chain technologies, permissioned and un-permissioned ledgers, shared ledgers and variations thereof. While Bitcoin and Ethereum may be referred to herein for the purpose of convenience and illustration, it should be noted that the disclosure is not limited to use with the Bitcoin or Ethereum blockchains and alternative blockchain implementations and protocols fall within the scope of the present disclosure.

It should also be noted that not all currently known distributed ledger systems utilize linear blockchains as such. Some known blockchain implementations utilize lattice or mesh data structure(s), and some utilize directed acyclic graphs (DAGs).

The teachings of all patents, published applications, and references cited herein are incorporated by reference in their entirety. The contents of the Appendix are incorporated herein by reference in their entirety.

While example embodiments have been particularly shown and described, it will be understood by those skilled in the art that various changes in form and details may be made therein without departing from the scope of the embodiments encompassed by the appended claims.

1. A blockchain computer system for computationally evolving digital assets and controlling digital asset transactions, the blockchain computer system comprising:
a blockchain computer network having a plurality of nodes configured to process transactions of digital assets; an encoder configured to encode, on the blockchain computer network, a smart contract, the smart contract being cryptographically configured to control at least one digital asset, wherein the encoder configures the smart contract to restrict transfer of the at least one digital asset in the blockchain computer network;
an embedded virtual machine (VM) configured to execute the smart contract on the blockchain computer network, wherein the smart contract configured to control the at least one digital asset enables the digital asset to computationally evolve in the blockchain computer network including enabling the at least one digital asset to:
based on at least one user activity value, computationally evolve the at least one digital asset into a computationally evolved digital asset; and
control, based on at least one threshold criterion, at least one transaction of the computationally evolved digital asset on the blockchain computer network.

2. The blockchain computer system of claim 1, wherein the smart contract is further configured as a loot box digital container;
the smart contract digital container is configured to track evolution of the at least one digital asset and unlock functionality of the at least one digital asset in response to computational transformation of the digital asset; and
the blockchain computer network is configured to implement a randomized mechanism for acquisition of a digital asset spawned from the at least one digital asset.

3. The blockchain computer system of claim 1, wherein the smart contract is further configured to generate a first initial attribute value for a first digital asset of the at least one digital asset, the first initial attribute value being equal to a second initial attribute value for a second digital asset of the at least one digital asset.

4. The blockchain computer system of claim 1, wherein the smart contract is further configured to generate a first exclusivity value for a first digital asset of the at least one digital asset, the first exclusivity value being different from a second exclusivity value for a second digital asset of the at least one digital asset.

5. The blockchain computer system of claim 1, wherein the smart contract is further configured to determine, based on an exclusivity value for a digital asset of the at least one digital asset, at least one attribute value threshold for the digital asset.

6. The blockchain computer system of claim 1, wherein the smart contract is further configured to determine, based on an exclusivity value for a digital asset of the at least one digital asset, at least one of: (i) at least one path of a computational evolution tree associated with the digital asset and (ii) a depth of the computational evolution tree.

7. The blockchain computer system of claim 1, wherein the at least one user activity value includes at least one of: (i) a user progress value in an electronic game platform, (ii) a user skill value in the electronic game platform, and (iii) a user performance value in the electronic game platform.

8. The blockchain computer system of claim 1, wherein a digital asset of the at least one digital asset has an associated computational evolution tree, and wherein the smart contract is further configured to:
determine, based on the at least one user activity value, at least one path of the associated computational evolution tree.

9. The blockchain computer system of claim 8, wherein the at least one user activity value includes a user progress value in an electronic game platform, and wherein the smart contract is further configured to:
determine, based on the user progress value, a digital asset attribute level path of the associated computational evolution tree.

10. The blockchain computer system of claim 8, wherein the at least one user activity value includes a user skill value in an electronic game platform, and wherein the smart contract is further configured to:
determine, based on the user skill value, a digital asset ability level path of the associated computational evolution tree;
wherein the determined digital asset ability level path relates to at least of one: (i) a trait of the digital asset in the electronic game platform, (ii) an item in the electronic game platform, and (iii) a skill of the digital asset in the electronic game platform;
wherein the trait of the digital asset includes a computational evolution trait digital token;
wherein the item in the electronic game platform includes at least one of: (i) a weapon in the electronic game platform and (ii) equipment in the electronic game platform.

11. (canceled)

12. (canceled)

13. (canceled)

14. The blockchain computer system of claim 8, wherein the at least one user activity value includes a user performance value in an electronic game platform, and wherein the smart contract is further configured to:
determine, based on the user skill value, a digital asset enhancement level path of the associated computational evolution tree;
wherein the user performance value includes a performance value for an event in the electronic game platform in the blockchain computer network.

15. (canceled)

16. The blockchain computer system of claim 1, wherein the computationally evolved digital asset is configured to encapsulate at least one permutation of user activity values;
wherein at least one user activity value includes a user skill value in an electronic game platform, and wherein the smart contract is further configured to:
generate, based on the user skill value, at least one computational evolution trait digital token; and
process at least one transaction of the at least one computational evolution trait digital token on the blockchain computer network.

17. (canceled)

18. A computer-implemented method for computationally evolving digital assets and controlling digital asset transactions, the computer-implemented method comprising:
processing transactions of digital assets in a blockchain computer network;
encoding, on the blockchain computer network, a smart contract, the smart contract being cryptographically configured to control at least one digital asset, wherein the encoder configures the smart contract to restrict transfer of the at least one digital asset in the blockchain computer network;
executing the smart contract on the blockchain computer network; and
enabling the at least one digital asset to computationally evolve in the blockchain computer network including:
based on at least one user activity value, computationally evolving at least one digital asset; and
controlling, based on at least one threshold criterion, at least one transaction of a computationally evolved digital asset of the at least one digital asset on the blockchain computer network.

19. The computer-implemented method of claim 18, further comprising:
configuring the smart contract as as a loot box digital container;
wherein the smart contract digital container is configured to track evolution of the at least one digital asset and unlock functionality of the at least one digital asset in response to computational transformation of the digital asset; and
implementing a randomized mechanism for acquisition of a digital asset of the at least one digital asset.

20. The computer-implemented method of claim 18, further comprising:
generating a first initial attribute value for a first digital asset of the at least one digital asset, the first initial attribute value being equal to a second initial attribute value for a second digital asset of the at least one digital asset; and
generating a first exclusivity value for a first digital asset of the at least one digital asset, the first exclusivity value being different from a second exclusivity value for a second digital asset of the at least one digital asset.

21. (canceled)

22. The computer-implemented method of claim 18, further comprising:
determining, based on an exclusivity value for a digital asset of the at least one digital asset, at least one attribute value threshold for the digital asset.

23. The computer-implemented method of claim 18, further comprising:
determining, based on an exclusivity value for a digital asset of the at least one digital asset, at least one of: (i) at least one path of a computational evolution tree associated with the digital asset and (ii) a depth of the computational evolution tree.

24. The computer-implemented method of claim 18, wherein the at least one user activity value includes at least one of: (i) a user progress value in an electronic game platform, (ii) a user skill value in the electronic game platform, and (iii) a user performance value in the electronic game platform.

25. The computer-implemented method of claim 18, wherein a digital asset of the at least one digital asset has an associated computational evolution tree, and further comprising:
determining, based on the at least one user activity value, at least one path of the associated computational evolution tree.

26. The computer-implemented method of claim 25, wherein the at least one user activity value includes a user progress value in an electronic game platform, and further comprising:
determining, based on the user progress value, a digital asset attribute level path of the associated computational evolution tree.

27. The computer-implemented method of claim 25, wherein the at least one user activity value includes a user skill value in an electronic game platform, and further comprising:
determining, based on the user skill value, a digital asset ability level path of the associated computational evolution tree;
wherein the determined digital asset ability level path relates to at least of one: (i) a trait of the digital asset in the electronic game platform, (ii) an item in the electronic game platform, and (iii) a skill of the digital asset in the electronic game platform;
wherein the trait of the digital asset includes a computational evolution trait digital token;
wherein the item in the electronic game platform includes at least one of: (i) a weapon in the electronic game platform and (ii) equipment in the electronic game platform.

28. (canceled)

29. (canceled)

30. (canceled)

31. The computer-implemented method of claim 25, wherein the at least one user activity value includes a user performance value in an electronic game platform, and further comprising:
determining, based on the user skill value, a digital asset enhancement level path of the associated computational evolution tree;
wherein the user performance value includes a performance value for an event in the electronic game platform in the blockchain computer network.

32. (canceled)

33. The computer-implemented method of claim 18, wherein the computationally evolved digital asset is configured to encapsulate at least one permutation of user activity values; wherein the at least one user activity value includes a user skill value in an electronic game platform, and further comprising:
generating, based on the user skill value, at least one computational evolution trait digital token; and
processing at least one transaction of the at least one computational evolution trait digital token on the blockchain computer network.

34. (canceled)

35. A computer-based system for computationally evolving digital assets and controlling digital asset transactions, the computer-based system comprising:
a blockchain computer network configured to process transactions of digital assets via a blockchain protocol, the blockchain computer network having multiple nodes,
at least one blockchain computing node of the multiple nodes including a secure cryptoprocessor implemented as a dedicated microprocessor configured to execute a virtual machine (VM) oracle, the virtual machine (VM) oracle embedded on the secure cryptoprocessor,
the virtual machine (VM) oracle configured to decode, via a decoder, a smart contract on the blockchain computer network,
the smart contract configured to:
based on at least one user activity value, computationally evolve at least one digital asset; and
control, based on at least one threshold criterion, at least one transaction of a computationally evolved digital asset of the at least one digital asset via the blockchain protocol.
